(19) United States
(12) Patent Application Publication
(10) Pub. No.: US 2025/0240407 A1
(43) Pub. Date: Jul. 24, 2025

(54) CODING OF POINT CLOUD FRAMES

(71) Applicant: QUALCOMM Incorporated, San Diego, CA (US)

(72) Inventors: Adarsh Krishnan Ramasubramonian, Irvine, CA (US); Geert Van der Auwera, San Diego, CA (US); Marta Karczewicz, San Diego, CA (US)

(21) Appl. No.: 18/989,624

(22) Filed: Dec. 20, 2024

Related U.S. Application Data
(60) Provisional application No. 63/624,619, filed on Jan. 24, 2024.

(51) Int. Cl. H04N 19/105; H04N 19/136; H04N 19/172; H04N 19/423; H04N 19/50; H04N 19/70

(52) U.S. Cl. CPC H04N 19/105; H04N 19/136; H04N 19/172; H04N 19/50; H04N 19/70; H04N 19/423

(57) ABSTRACT

Techniques, methods, and devices for encoding point cloud data and for decoding point cloud data are described. An example point cloud compression decoder includes one or more memories configured to store the point cloud data and one or more processors operatively coupled to the one or more memories. The one or more processors are configured to determine a type-length-value (TLV) type of a current data unit of the point cloud data, the TLV type being indicative of a reference status of the current data unit. The one or more processors are configured to determine, based on the TLV type, the reference status. The one or more processors are configured to decode the current data unit in accordance the reference status.

This application claims the benefit of U.S. Provisional Patent Application 63/624,619, filed Jan. 24, 2024, the entire content of which is incorporated by reference.

### TECHNICAL FIELD

This disclosure relates to point cloud encoding and decoding.

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for encoding and decoding point clouds. Encoding point clouds may reduce the amount of data required for storage and transmission of point clouds.

### SUMMARY

In general, this disclosure describes techniques for coding of point cloud frames. More particularly, this disclosure describes techniques for identifying which data units of point cloud data may be used as a reference, may not be used as a reference, shall be used for a reference, or shall not be used for a reference. This disclosure also describes techniques for simplifying scale-offset computation in spherical coordinate conversion.

In some point cloud compression standards and implementations, there is no way for a point cloud decoder, such as a Geometry Point Cloud Compression (G-PCC) decoder, to determine whether or not a particular data unit may later be used as a reference. This situation causes the point cloud decoder to have to store that particular data unit for a period of time after the point cloud frame to which the particular data unit belongs is rendered, even if that particular data unit is never going to be used as a reference. This increases the need for storage of decoded data units. The techniques of this disclosure may reduce the need for storage of decoded data units that will not be used as a reference. In some cases, all the data units in a frame F1 (either geometry, or attribute, or both) may not be used as a reference by any other frame (e.g., may not be used for inter prediction by any other frame). In such cases, storing such a frame F1 beyond when it is needed to be output would increase the need for storage of the frame.

In some point cloud compression standards and implementations, a scale-offset computation includes a number of operations, including an expensive multiplication. The techniques of this disclosure may remove the multiplication and thereby reduce the complexity of encoder and/or decoder implementations and/or reduce processing power used when performing a scale-offset computation.

In one example, this disclosure describes a method of decoding point cloud data, the method including: determining a type-length-value (TLV) type of a current data unit of the point cloud data, the TLV type being indicative of a reference status of the current data unit; determining, based on the TLV type, the reference status; and decoding the current data unit in accordance the reference status.

In another example, this disclosure describes a device for decoding point cloud data, the device including: one or more memories configured to store the point cloud data; and one or more processors operatively coupled to the one or more memories, the one or more processors configured to: determine a type-length-value (TLV) type of a current data unit of the point cloud data, the TLV type being indicative of a reference status of the current data unit; determine, based on the TLV type, the reference status; and decode the current data unit in accordance the reference status.

In another example, this disclosure describes method of encoding point cloud data, the method including: determining a reference status of a current data unit of the point cloud data; determining, based on the reference status, a type-length-value (TLV) type of the current data unit, the TLV type being indicative of the reference status; and encoding the current data unit in accordance with the TLV type.

In another example, this disclosure describes a device for encoding point cloud data, the device including: one or more memories configured to store the point cloud data: and one or more processors operatively coupled to the one or more memories, the one or more processors configured to: determine a reference status of a current data unit of the point cloud data; determine, based on the reference status, a type-length-value (TLV) type of the current data unit, the TLV type being indicative of the reference status; and encode the current data unit in accordance with the TLV type.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 is a block diagram illustrating an example Geometry Point Cloud Compression (G-PCC) encoder.

FIG. 3 is a block diagram illustrating an example G-PCC decoder.

FIG. 4 is an example Octree split for geometry coding according to the techniques of this disclosure.

FIG. 5 is a conceptual diagram illustrating an example of a prediction tree, in accordance with one or more techniques of this disclosure.

FIGS. 6A and 6B are conceptual diagrams illustrating an example of a spinning LIDAR acquisition model.

FIG. 7 is a conceptual diagram illustrating an example of inter-prediction of a current point (curPoint) from a point (interPredPt) in a reference frame.

FIG. 8 is a flow diagram illustrating example operation of a G-PCC decoder.

FIG. 9 is a conceptual diagram illustrating an example of an additional inter predictor point obtained from the first point that has an azimuth greater than the inter predictor point.

FIG. 10 is a flow diagram illustrating an example of motion compensation techniques where the reference frame is in the spherical domain and the motion compensation is applied in the Cartesian domain.

FIG. 11 is a conceptual diagram illustrating an example of azimuth resampling of motion compensated references.

FIG. 12 is a block diagram illustrating an example geometry encoding unit of FIG. 2 in more detail.

FIG. 13 is a block diagram illustrating an example attribute encoding unit of FIG. 2 in more detail.

FIG. 14 is a block diagram illustrating an example geometry decoding unit of FIG. 3 in more detail.

FIG. 15 is a block diagram illustrating an example attribute decoding unit of FIG. 3 in more detail.

FIG. 16 is a flow diagram illustrating an example of spherical coordinate conversion according to one or more aspects of this disclosure.

FIG. 17 is a flow diagram illustrating example point cloud encoding techniques according to one or more aspects of this disclosure.

FIG. 18 is a flow diagram illustrating example point cloud decoding techniques according to one or more aspects of this disclosure.

FIG. 19 is a conceptual diagram illustrating an example range-finding system that may be used with one or more techniques of this disclosure.

FIG. 20 is a conceptual diagram illustrating an example vehicle-based scenario in which one or more techniques of this disclosure may be used.

FIG. 21 is a conceptual diagram illustrating an example extended reality system in which one or more techniques of this disclosure may be used.

FIG. 22 is a conceptual diagram illustrating an example mobile device system in which one or more techniques of this disclosure may be used.

### DETAILED DESCRIPTION

In some standards and implementations, there is no indication in the bitstream sent by a G-PCC encoder as to whether a point cloud frame (e.g., a point cloud picture) may be used as a reference for prediction of another frame. As a result, a G-PCC decoder stores a current picture after decoding, even when no other picture may use the current picture for prediction. This results in the storage of additional potential reference frames that may not be needed, resulting in additional (e.g., larger) buffer requirements. Moreover, when a network element or transcoder is quickly decoding the bitstream, or a G-PCC decoder is decoding the bitstream for trick play purposes, pictures that are not used for reference (e.g., that are not actual reference pictures) may be discarded entirely. In the absence of an indicator, the network element/decoder/transcoder must parse the byte stream to decode syntax elements that may describe the reference picture structure. This poses an unnecessary burden on these entities.

Spherical coordinate conversion (SCC) uses a scale and offset which involves one multiplication, two additions (e.g., 1 addition and 1 subtraction), and one shift operation for each point in each of the three dimensions. A multiplication operation is typically more complex than a shift operation. Therefore, if the multiplication operation in SCC can be replaced (e.g., by a shift operation), the computational complexity for a G-PCC encoder and/or a G-PCC decoder would be reduced.

As such, it may also be desirable to provide an indication of which data units may be used as a reference (e.g., is eligible to be used as a reference by G-PCC decoder 300), and which data unites shall not be used as a reference (e.g., is not eligible to be used as a reference by G-PCC decoder 300). Such an indication may be through a use of a particular type-length-value (TLV) type (sometimes referred to as a tag-length-value) or through syntax signaled in a data unit syntax structure. It may also be desirable to provide a technique for simplifying scale-offset computation in spherical coordinate conversion.

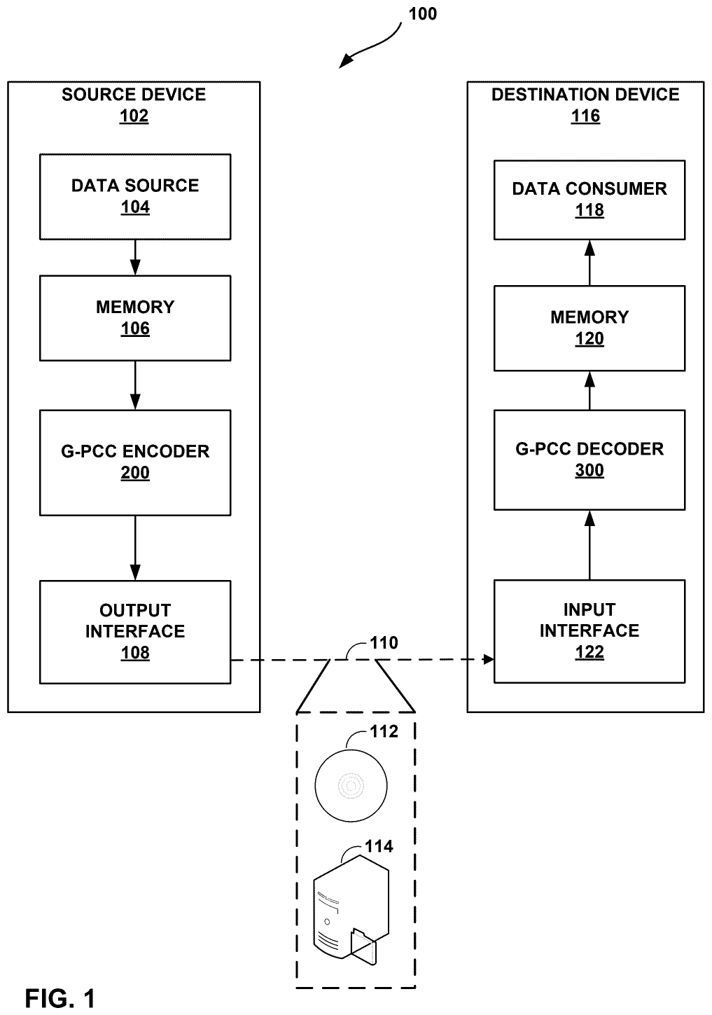

FIG. 1 is a block diagram illustrating an example encoding and decoding system 100 that may perform the techniques of this disclosure. The techniques of this disclosure are generally directed to coding (encoding and/or decoding) point cloud data, i.e., to support point cloud compression. In general, point cloud data includes any data for processing a point cloud. The coding may be effective in compressing and/or decompressing point cloud data.

As shown in FIG. 1, system 100 includes a source device 102 and a destination device 116. Source device 102 provides encoded point cloud data to be decoded by a destination device 116. Particularly, in the example of FIG. 1, source device 102 provides the point cloud data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a G-PCC encoder 200, and an output interface 108. Destination device 116 includes an input interface 122, a G-PCC decoder 300, a memory 120, and a data consumer 118. In accordance with this disclosure, G-PCC encoder 200 of source device 102 and G-PCC decoder 300 of destination device 116 may be configured to apply the techniques of this disclosure related to coding point cloud data. Thus, source device 102 represents an example of an encoding device, while destination device 116 represents an example of a decoding device. In other examples, source device 102 and destination device 116 may include other components or arrangements. For example, source device 102 may receive data (e.g., point cloud data) from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to code point cloud data. Source device 102 and destination device 116 are merely examples of such devices in which source device 102 generates coded data for transmission to destination device 116. This disclosure refers to a “coding” device as a device that performs coding (encoding and/or decoding) of data. Thus, G-PCC encoder 200 and G-PCC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded point cloud data) and may provide a sequential series of “frames”) of the data to G-PCC encoder 200, which encodes data for the frames. Data source 104 of source device 102 may include a point cloud capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, point cloud data may be computer-generated from scanner, camera, sensor or other data. For example, data source 104 may generate computer graphics-based data as the source data, or produce a combination of live data, archived data, and computer-generated data. In each case, G-PCC encoder 200 encodes the captured, pre-captured, or computer-generated data. G-PCC encoder 200 may rearrange the frames from the received order (sometimes referred to as “display order”) into a coding order for coding. G-PCC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from G-PCC decoder 300. Additionally or alternatively, memory 106 and memory 120 may store software instructions executable by, e.g., G-PCC encoder 200 and G-PCC decoder 300, respectively. Although memory 106 and memory 120 are shown separately from G-PCC encoder 200 and G-PCC decoder 300 in this example, it should be understood that G-PCC encoder 200 and G-PCC decoder 300 may also include internal memories for functionally similar or equivalent purposes. Furthermore, memory 106 and memory 120 may store encoded data, e.g., output from G-PCC encoder 200 and input to G-PCC decoder 300. In some examples, portions of memory 106 and memory 120 may be allocated as one or more buffers, e.g., to store raw, decoded, and/or encoded data. For instance, memory 106 and memory 120 may store data representing a point cloud.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to G-PCC encoder 200 and/or output interface 108, and destination device 116 may include an SoC device to perform the functionality attributed to G-PCC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by G-PCC encoder 200, which is also used by G-PCC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on a point cloud.

G-PCC encoder 200 and G-PCC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of G-PCC encoder 200 and G-PCC decoder 300 may be included in one or more encoders or decoders, either of which may be integrated as part of a combined encoder/decoder (CODEC) in a respective device. A device including G-PCC encoder 200 and/or G-PCC decoder 300 may comprise one or more integrated circuits, microprocessors, and/or other types of devices.

G-PCC encoder 200 and G-PCC decoder 300 may operate according to a coding standard, such as video point cloud compression (V-PCC) standard or a geometry point cloud compression (G-PCC) standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, G-PCC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

ISO/IEC MPEG (JTC 1/SC 29/WG 11), and more recently ISO/IEC MPEG 3DG (JTC 1/SC29/WG 7), is studying the potential need for standardization of point cloud coding technology with a compression capability that significantly exceeds that of the current approaches and will target to create the standard. The group is working together on this exploration activity in a collaborative effort known as the 3-Dimensional Graphics Team (3DG) to evaluate compression technology designs proposed by their experts in this area.

Point cloud compression activities are categorized in two different approaches. The first approach is “Video point cloud compression” (V-PCC), which segments the 3D object, and project the segments in multiple 2D planes (which are represented as “patches” in the 2D frame), which are further coded by a legacy 2D video codec such as a High Efficiency Video Coding (HEVC) (ITU-T H.265) codec. The second approach is “Geometry-based point cloud compression” (G-PCC), which directly compresses 3D geometry i.e., position of a set of points in 3D space, and associated attribute values (for each point associated with the 3D geometry). G-PCC addresses the compression of point clouds in both Category 1 (static point clouds) and Category 3 (dynamically acquired point clouds). A recent draft of the G-PCC standard is available in the Text of ISO/IEC FDIS 23090-9 Geometry-based Point Cloud Compression, ISO/IEC JTC 1/SC29/WG 7 m55637, Teleconference, October 2020, and a description, and a description of the codec is available in G-PCC 2nd Edition Codec Description, ISO/IEC JTC 1/SC29/WG 7 MDS21684, Teleconference, July 2022.

A point cloud contains a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

The 3D space occupied by a point cloud data may be enclosed by a virtual bounding box. The position of the points in the bounding box may be represented by a certain precision; therefore, the positions of one or more points may be quantized based on the precision. At the smallest level, the bounding box is split into voxels which are the smallest unit of space represented by a unit cube. A voxel in the bounding box may be associated with zero, one, or more than one point. The bounding box may be split into multiple cube/cuboid regions, which may be called tiles. Each tile may be coded into one or more slices. The partitioning of the bounding box into slices and tiles may be based on number of points in each partition, or based on other considerations (e.g., a particular region may be coded as tiles). The slice regions may be further partitioned using splitting decisions similar to those in video codecs.

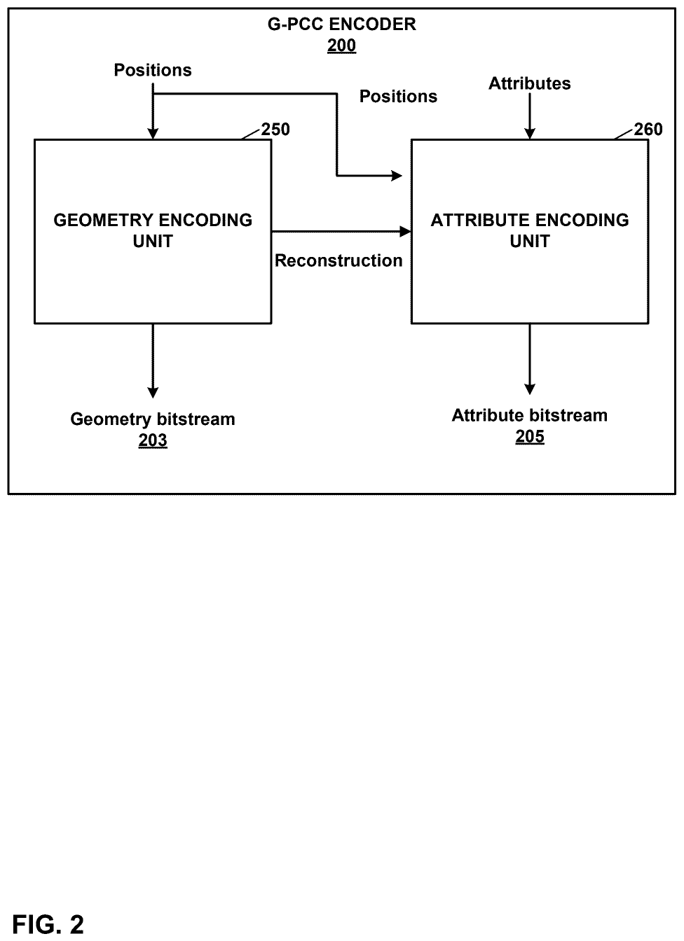

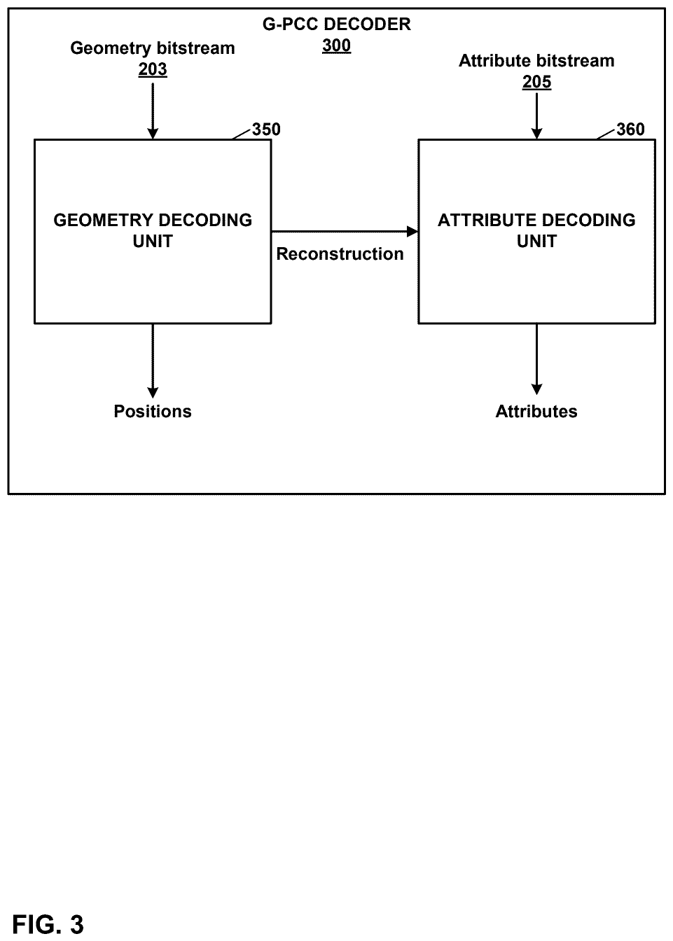

FIG. 2 provides an overview of G-PCC encoder 200. FIG. 3 provides an overview of G-PCC decoder 300. The modules shown are logical, and do not necessarily correspond one-to-one to implemented code. In the example of FIG. 2, G-PCC encoder 200 may include a geometry encoding unit 250 and an attribute encoding unit 260. In general, geometry encoding unit 250 is configured to encode the positions of points in the point cloud frame to produce geometry bitstream 203. Attribute encoding unit 260 is configured to encode the attributes of the points of the point cloud frame to produce attribute bitstream 205. As will be explained below, attribute encoding unit 260 may also use the positions, as well as the encoded geometry (e.g., the reconstruction) from geometry encoding unit 250 to encode the attributes.

In the example of FIG. 3, G-PCC decoder 300 may include a geometry decoding unit 350 and an attribute decoding unit 360. In general, geometry decoding unit 350 is configured to decode the geometry bitstream 203 to recover the positions of points in the point cloud frame. Attribute decoding unit 360 is configured to decode the attribute bitstream 205 to recover the attributes of the points of the point cloud frame. As will be explained below, attribute decoding unit 360 may also use the positions from the decoded geometry (e.g., the reconstruction) from geometry decoding unit 350 to encode the attributes.

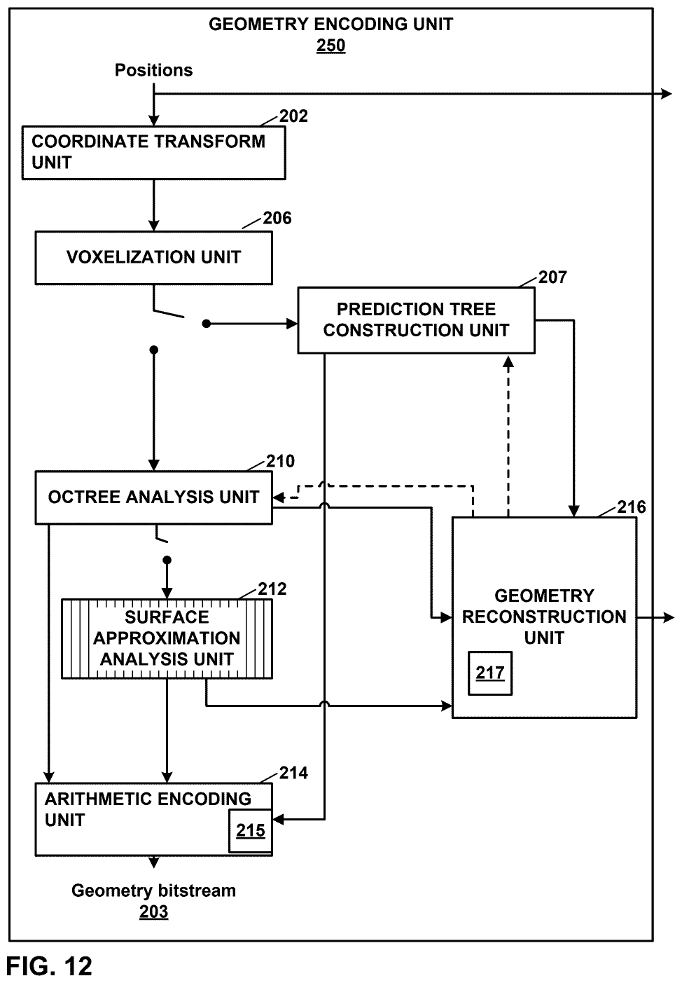

In both G-PCC encoder 200 and G-PCC decoder 300, point cloud positions are coded first. Attribute coding depends on the decoded geometry. In FIGS. 12-15 of this disclosure, the coding units with vertical hashing are options typically used for Category 1 data. Diagonal-crosshatched coding units are options typically used for Category 3 data. All the other modules are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

At each node of an octree, an occupancy is signaled (when not inferred) for one or more of its child nodes (up to eight nodes). Multiple neighborhoods are specified including (a) nodes that share a face with a current octree node, (b) nodes that share a face, edge or a vertex with the current octree node, etc. Within each neighborhood, the occupancy of a node and/or its children may be used to predict the occupancy of the current node or its children. For points that are sparsely populated in certain nodes of the octree, the codec also supports a direct coding mode where the 3D position of the point is encoded directly. A flag may be signaled to indicate that a direct mode is signaled. At the lowest level, the number of points associated with the octree node/leaf node may also be coded.

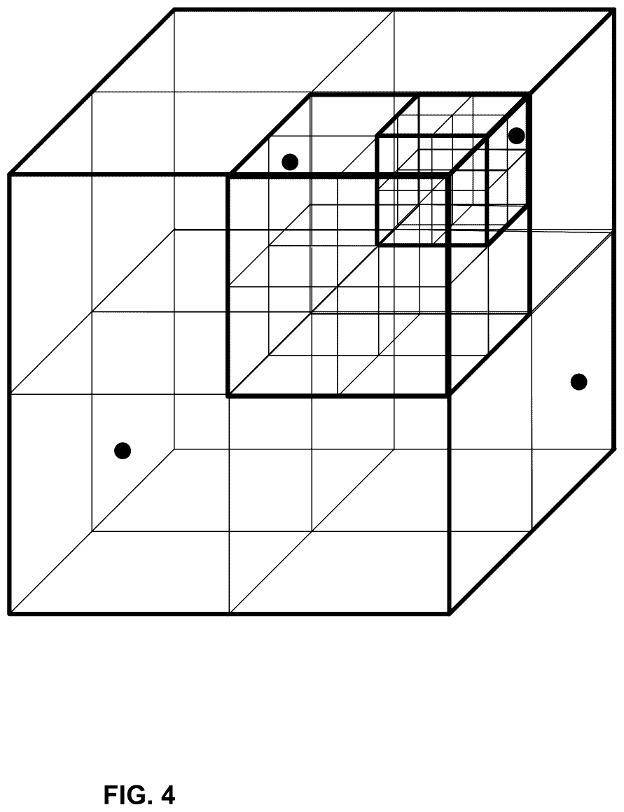

FIG. 4 is an example Octree split for geometry coding according to the techniques of this disclosure.

Once the geometry is coded, the attributes corresponding to the geometry points are coded. When there are multiple attribute points corresponding to one reconstructed/decoded geometry point, an attribute value may be derived that is representative of the reconstructed point.

There are three attribute coding methods in G-PCC: Region Adaptive Hierarchical Transform (RAHT) coding, interpolation-based hierarchical nearest-neighbour prediction (Predicting Transform), and interpolation-based hierarchical nearest-neighbour prediction with an update/lifting step (Lifting Transform). RAHT and Lifting are typically used for Category 1 data, while Predicting is typically used for Category 3 data. However, either method may be used for any data, and, just like with the geometry codecs in G-PCC, the attribute coding method used to code the point cloud is specified in the bitstream.

The coding of the attributes may be conducted in a level-of-detail (LoD), where with each level of detail a finer representation of the point cloud attribute may be obtained. Each level of detail may be specified based on distance metric from the neighboring nodes or based on a sampling distance.

At G-PCC encoder 200, the residuals obtained as the output of the coding methods for the attributes are quantized. The residuals may be obtained by subtracting the attribute value from a prediction that is derived based on the points in the neighborhood of the current point and based on the attribute values of points encoded previously. The quantized residuals may be coded using context adaptive arithmetic coding.

G-PCC encoder 200 and G-PCC decoder 300 may be configured to code point cloud data using predictive geometry coding as an alternative to the octree geometry coding. In prediction tree coding, the nodes of the point cloud are arranged in a tree structure (which defines the prediction structure), and various prediction strategies are used to predict the coordinates of each node in the tree with respect to its predictors. A node that is the root vertex and has no predictors. Other nodes may have 1, 2, 3 or more children. Other nodes may be leaf nodes that have no children. In one example, every node of the predictive has only one parent node.

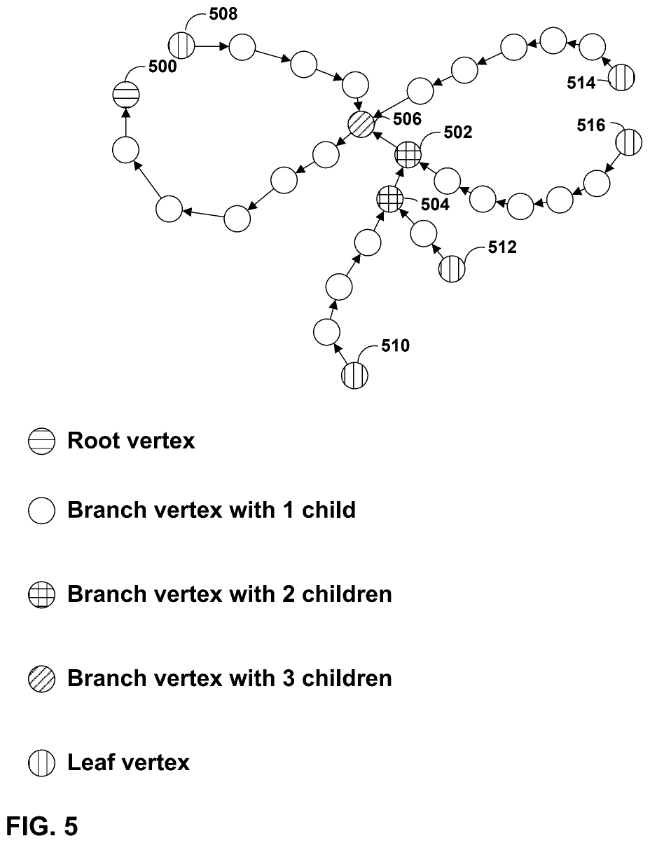

FIG. 5 is a conceptual diagram illustrating an example of a prediction tree, in accordance with one or more techniques of this disclosure. Node 500 is the root vertex and has no predictors. Nodes 502 and 504 have two children. Node 506 has 3 children. Nodes 508, 510, 512, 514, and 516 are leaf nodes and these have no children. The remaining nodes each have one child. Every node aside from root node 500 has only one parent node.

In one example, four prediction strategies are specified for each node based on its parent (p0), grand-parent (p1) and great-grand-parent (p2):
No prediction/zero prediction (0)
Delta prediction (p0)
Linear prediction (2*p0-p1)
Parallelogram prediction (p0+p1-p2)

G-PCC encoder 200 may employ any algorithm to generate the prediction tree; the algorithm used may be determined based on the application/use case and several strategies may be used. For each node, the residual coordinate values are coded in the bitstream starting from the root node in a depth-first manner. Predictive geometry coding may be particularly useful for Category 3 (LIDAR-acquired) point cloud data, e.g., for low-latency applications.

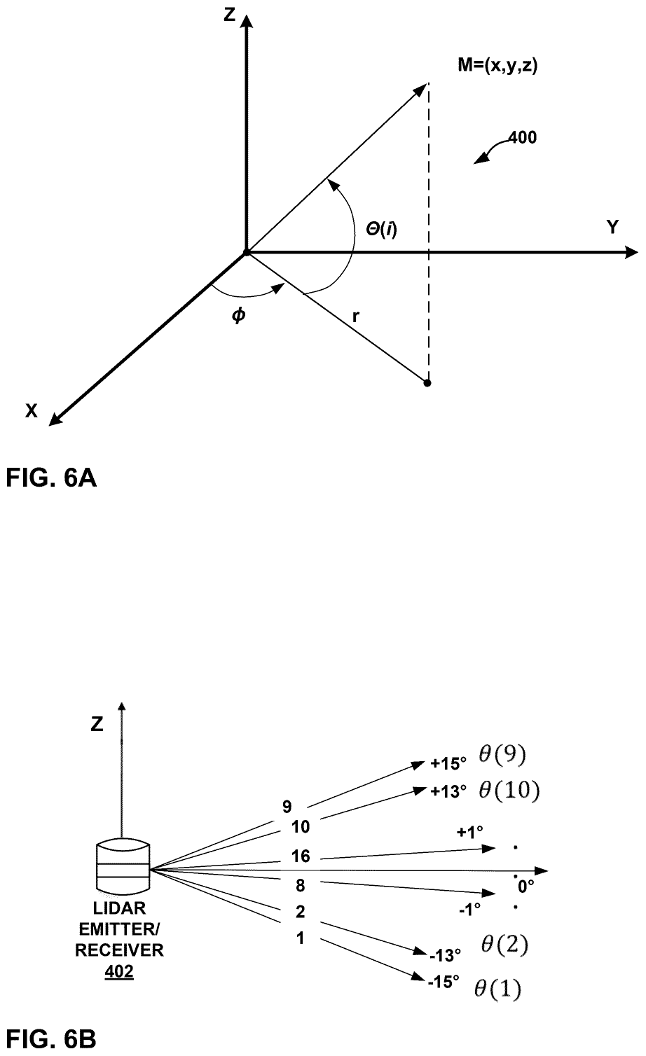

FIGS. 6A and 6B are conceptual diagrams illustrating an example of a spinning LIDAR acquisition model. LIDAR 402 may be used in automotive, mobile computing, aviation, and other scenarios. In some examples, angular mode may be used in predictive geometry coding, where the characteristics of LIDAR sensors may be utilized in coding the prediction tree more efficiently. The coordinates of the positions are converted to the (r, ϕ, i) (radius, azimuth and laser index) domain 400 and a prediction is performed in this domain 400 (the residuals are coded in r, ϕ, i domain). Due to the errors in rounding, coding in r, ϕ, i is not lossless and hence a second set of residuals are coded which correspond to the Cartesian coordinates. A description of the encoding and decoding strategies used for angular mode for predictive geometry coding is provided below.

Angular mode for predictive geometry coding may be used with point clouds acquired using a spinning LIDAR model. Here, the LIDAR 402 has N lasers (e.g., N=16, 32, 64) spinning around the Z axis according to an azimuth angle ϕ. Each laser may have different elevation θ(i)_{i=1 . . . N} and height [symbol] (i)_{i=1 . . . N}. In one example, laser i hits a point M, with cartesian integer coordinates (x, y, z), defined according to the coordinate system of an example spinning LIDAR acquisition model shown in FIGS. 6A-6B

Angular mode for predictive geometry coding may include modelling the position of M with three parameters (r, ϕ, i), which are computed as follows:

$$r = \sqrt{{x}^{2} + {y}^{2}}$$

$$ϕ = atan 2 ( y , x )$$

$$i = arg {min}_{j = 1 … N} \{ z + ϛ ( j ) - r \times tan ( θ ( j ) ) \} ,$$

More precisely, angular mode for predictive geometry coding uses the quantized version of (r, ϕ, i), denoted (\tilde{r}, \tilde{ϕ}, i), where the three integers \tilde{r}, \tilde{ϕ} and i are computed as follows:

$$\tilde{r} = floor ( \frac{\sqrt{{x}^{2} + {y}^{2}}}{{q}_{r}} + {o}_{r} ) = hypot ( x , y )$$

$$\tilde{ϕ} = sign ( atan 2 ( y , x ) ) \times floor ( \frac{\vert atan 2 ( y , x ) \vert}{{q}_{ϕ}} + {o}_{ϕ} )$$

$$i = arg {min}_{j = 1 … N} \{ z + ϛ ( j ) - r \times tan ( θ ( j ) ) \}$$

where
(qᵣ, oᵣ) and (q_{ϕ}, o_{ϕ}) are quantization parameters controlling the precision of \tilde{ϕ} and \tilde{r}, respectively.
sign(t) is the function that return 1 if t is positive and (−1) otherwise.
   |t| is the absolute value of t.

To avoid reconstruction mismatches due to the use of floating-point operations, the values of [symbol] (i)_{i=1 . . . N} and tan(θ(i))_{i=1 . . . N} may be pre-computed and quantized as follows:

$$\tilde{z} ( i ) = sign ( ϛ ( i ) ) \times floor ( \frac{\vert ϛ ( i ) \vert}{{q}_{ϛ}} + {o}_{ϛ} )$$

$$\tilde{t} ( i ) = sign ( ϛ ( tan ( θ ( j ) ) ) \times floor ( \frac{\vert tan ( θ ( j ) \vert}{{q}_{θ}} + {o}_{θ} )$$

where
[symbol] and (q_{θ}, o_{θ}) are quantization parameters controlling the precision of [symbol] and \tilde{θ}, respectively.

The reconstructed cartesian coordinates are obtained as follows:

$$\hat{x} = round ( \tilde{r} \times {q}_{r} \times app\_cos ( \tilde{ϕ} \times {q}_{ϕ} ) )$$

$$\hat{y} = round ( \tilde{r} \times {q}_{r} \times app\_sin ( \tilde{ϕ} \times {q}_{ϕ} ) )$$

$$\hat{z} = round ( \tilde{r} \times {q}_{r} \times \tilde{t} ( i ) \times {q}_{θ} - \tilde{z} ( i ) \times {q}_{ϛ} ) ,$$

where app_cos(.) and app_sin(.) are approximation of cos(.) and sin(.). The calculations could be performed using a fixed-point representation, a look-up table, and linear interpolation.

Note that (\hat{x}, ŷ, \hat{z}) may be different from (x, y, z) due to various reasons:
quantization
approximations
model imprecision
model parameters imprecisions
   Let (rₓ, r_{y}, r_{z}) be the reconstruction residuals defined as follows:

$${r}_{x} = x - \hat{x}$$

$${r}_{y} = y - \hat{y}$$

$${r}_{z} = z - \hat{z}$$

In this method, G-PCC encoder 200 may proceed as follows:
Encode the model parameters \acute{t}(i) and \tilde{2}(i) and the quantization parameters qᵣ q [symbol] , q_{θ} and q_{ϕ}
Apply a geometry predictive scheme to the representation (r, \tilde{ϕ}, i)
   A new predictor leveraging the characteristics of LIDAR could be introduced. For instance, the rotation speed of the LIDAR scanner around the z-axis is usually constant. Therefore, G-PCC encoder 200 may predict the current \tilde{ϕ}(j) as follows:

$$\tilde{ϕ} ( j ) = \tilde{ϕ} ( j - 1 ) + n ( j ) \times {δ}_{ϕ} ( k )$$

### Where

(δ_{ϕ}(k))_{k=1 . . . K} is a set of potential speeds the encoder could choose from. The index k could be explicitly written to the bitstream or could be inferred from the context based on a deterministic strategy applied by both G-PCC encoder 200 and G-PCC decoder 300, and
n(j) is the number of skipped points which could be explicitly written to the bitstream or could be inferred from the context based on a deterministic strategy applied by both the encoder and the decoder. It is also referred to as “phi multiplier” later. Note, it is currently used only with delta predictor.
Encode with each node the reconstruction residuals (rₓ, r_{y}, r_{z})

G-PCC decoder 300 may proceed as follows:
Decode the model parameters \tilde{t}(i) and \tilde{z}(i) and the quantization parameters qᵣ q [symbol] , q_{θ} and q_{ϕ}
Decode the (\tilde{r}, \tilde{ϕ}, i) parameters associated with the nodes according to the geometry predictive scheme used by G-PCC encoder 200.
Compute the reconstructed coordinates (\hat{x}, ŷ, \hat{z}) as described above.
Decode the residuals (rₓ, r_{y}, r_{z})
   As discussed in the next section, lossy compression could be supported by quantizing the reconstruction residuals (rₓ, r_{y}, r_{z})
Compute the original coordinates (x, y, z) as follows

$$x = {r}_{x} + \hat{x}$$

$$y = {r}_{y} + \hat{y}$$

$$z = {r}_{z} + \hat{z}$$

Lossy compression may be achieved by applying quantization to the reconstruction residuals (rₓ, r_{y}, r_{z}) or by dropping points.

The quantized reconstruction residuals may be computed as follows:

$${\tilde{r}}_{x} = sign ( {r}_{x} ) \times floor ( \frac{\vert {r}_{x} \vert}{{q}_{x}} + {o}_{x} )$$

$${\tilde{r}}_{y} = sign ( {r}_{y} ) \times floor ( \frac{\vert {r}_{y} \vert}{{q}_{y}} + {o}_{y} )$$

$${\tilde{r}}_{z} = sign ( {r}_{z} ) \times floor ( \frac{\vert {r}_{z} \vert}{{q}_{z}} + {o}_{z} )$$

Where (qₓ, oₓ), (q_{y}, o_{y}) and (q_{z}, o_{z}) are quantization parameters controlling the precision of \tilde{r}ₓ, \tilde{r}_{y} and \tilde{r}_{z}, respectively.

Trellis quantization may be used to further improve the RD (rate-distortion) performance results. The quantization parameters may change at sequence/frame/slice/block level to achieve region adaptive quality and for rate control purposes.

The attribute coding, octree geometry coding, and predictive tree geometry coding techniques may be performed as intra prediction coding techniques. That is, G-PCC encoder 200 and G-PCC decoder 300 may code attribute and position data using only information from the frame of point cloud data being coded. In other examples, G-PCC encoder 200 and G-PCC decoder 300 may attributes, octree geometry, and/or predictive tree geometry using inter prediction techniques. That is, G-PCC encoder 200 and G-PCC decoder 300 may code attribute and position data using information from the frame of point cloud data being coded as well as information from previously-coded frames of point cloud data.

As described above, one example of predictive geometry coding uses a prediction tree structure to predict the positions of the points. When angular coding is enabled, the x, y, z coordinates are transformed to radius, azimuth and laserID and residuals are signaled in these three coordinates as well as in the x, y, z dimensions. The intra prediction used for radius, azimuth and laserID may be one of four modes and the predictors are the nodes that are classified as parent, grand-parent and great-grandparent in the prediction tree with respect to the current node. In one example, predictive geometry coding may be configured as an intra coding tool as it only uses points in the same frame for prediction. However, using points from previously-decoded frames (e.g., inter-prediction) may provide a better prediction and thus better compression performance in some circumstances.

For predictive geometry coding using inter prediction, one technique involves predicting the radius of a point from a reference frame. For each point in the prediction tree, it is determined whether the point is inter predicted or intra predicted (indicated by a flag). When intra predicted, the intra prediction modes of predictive geometry coding are used. When inter-prediction is used, the azimuth and laserID are still predicted with intra prediction, while the radius is predicted from the point in the reference frame that has the same laserID as the current point and an azimuth that is closest to the current azimuth. Another example of this method enables inter prediction of the azimuth and laserID in addition to radius prediction. When inter-coding is applied, the radius, azimuth and laserID of the current point are predicted based on a point that is near the azimuth position of a previously decoded point in the reference frame. In addition, separate sets of contexts are used for inter and intra prediction.

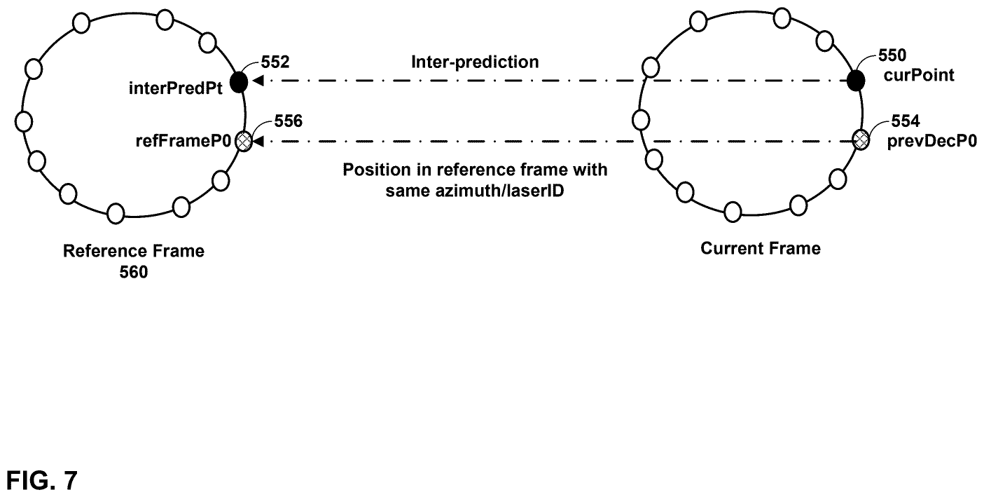

FIG. 7 is a conceptual diagram illustrating an example of inter-prediction of a current point (curPoint) 550 in a current frame from a point (interPredPt) 552 in the reference frame. The extension of inter prediction to azimuth, radius, and laserID may include the following steps:
For a given point, choose the previous decoded point (prevDecP0) 554.
Choose a position point (refFrameP0) 556 in the reference frame that has same scaled azimuth and laserID as prevDecP0 554.
In the reference frame, find the first point (interPredPt) 552 that has azimuth greater than that of refFrameP0 556. The point interPredPt 552 may also be referred to as the “Next” inter predictor.

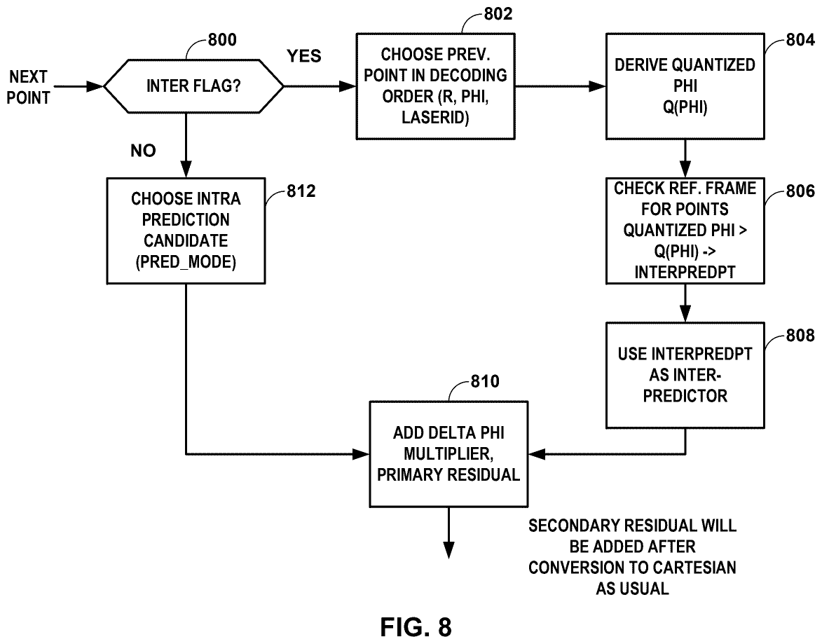

FIG. 8 is a flow diagram illustrating example operation of a G-PCC decoder. FIG. 8 illustrates the decoding flow associated with the “inter_flag” that is signalled for every point. The technique is available in InterEM-v3.0.

For example, G-PCC decoder 300 may determine whether the inter flag is true (e.g., equal to 1) (800). If the inter flag is true (the “YES” path from block 800), G-PCC decoder 300 may choose a previous decoded point in decoding order using radius, azimuth, and laserID (802). G-PCC decoder 300 may derive a quantized phi, Q(phi) (e.g., a quantized value of the azimuth) of the chosen previous decoded point (e.g., prevDecP0 554) (804). G-PCC decoder 300 may check the reference frame (e.g., reference frame 560 of FIG. 7) for points where the quantized phi of such points is greater than Q(phi) which may lead to interPredPt 552 (806). G-PCC decoder 300 may then use interPredPt 552 as an inter-predictor for the current point, curPoint 550 (808). G-PCC decoder 300 may then add a delta phi multiplier, e.g., n(j)×δ_{ϕ}(k) as discussed above, to the primary residual (810).

If the inter flag is false (e.g., is equal to 0) (the “NO” path from block 800), G-PCC decoder 300 may choose an intra prediction candidate (812) and apply intra prediction. G-PCC decoder 300 may then add a delta phi multiplier to yield the primary residual (810).

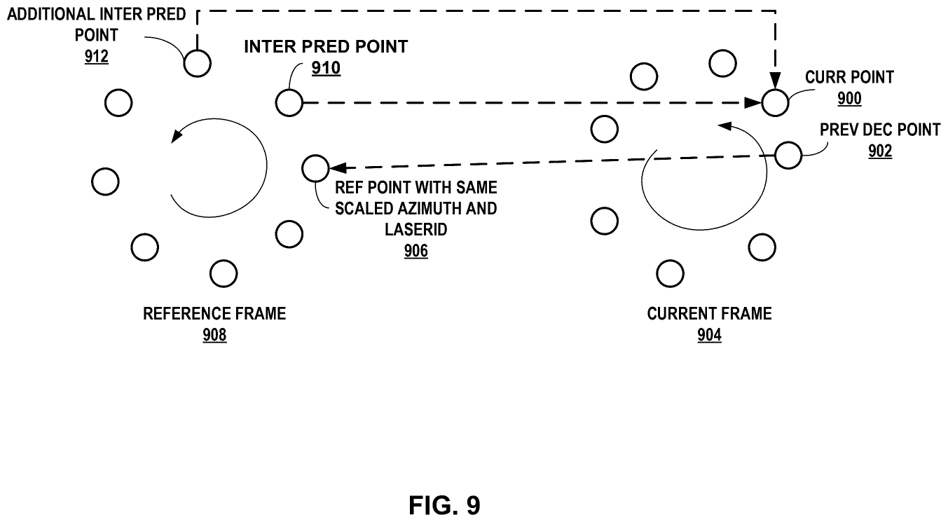

FIG. 9 is a conceptual diagram illustrating an example of an additional inter predictor point obtained from the first point that has an azimuth greater than the inter predictor point. An additional predictor candidate is now discussed. Information relating to the additional predictor candidate may be found in K. L. Loi, T. Nishi, T. Sugio, [G-PCC][New] Inter Prediction for Improved Quantization of Azimuthal Angle in Predictive Geometry Coding, ISO/IEC JTC1/SC29/WG7 m57351, July 2021. In the inter prediction technique for predictive geometry described above, the radius, azimuth, and laserID of the current point are predicted based on a point that is near the collocated azimuth position in the reference frame when inter coding is applied, for example, by G-PCC decoder 300, using the following steps:
1) for a given point (e.g., a current point, Curr Point 900), choose the previous decoded point (e.g., Prev Dec Point 902) of current frame 904,
2) choose a position (e.g., Ref Point 906) in reference frame 908 that has the same scaled azimuth and laserID as the previous decoded point (e.g., Prev Dec Point 902),
3) choose a position (Inter Pred Point 910) in reference frame 908 from the first point that has azimuth greater than the position in reference frame 908 that has the same scaled azimuth and laserID as the previous decoded point (e.g., Prev Dec Point 902), to be used as the inter predictor point.

This technique adds an additional inter predictor point 912 that is obtained by finding the first point that has an azimuth greater than the inter predictor point (e.g., Inter Pred Point 910) as shown in FIG. 9. Additional signaling is used to indicate which of the predictors is selected if inter coding has been applied by G-PCC encoder 200. For example, G-PCC encoder 200 may signal to G-PCC decoder 300 which of the predictors is selected. The additional inter predictor point may also be referred to as the “NextNext” inter predictor.

Inter prediction flag coding is now discussed. Information regarding such inter prediction flag coding may be found in A. K. Ramasubramonian, L. Pham Van, G. Van der Auwera, M. Karczewicz, [G-PCC]I[New proposal] Improvements to inter prediction using predictive geometry coding, ISO/IEC JTC1/SC29/WG7 m57299, July 2021. A context selection algorithm may be applied for coding the inter prediction flag. G-PCC encoder 200 may use the inter prediction flag values of the five previously coded points to select the context of the inter prediction flag in predictive geometry coding.

Global motion compensation is now described. When global motion (GM) parameters are available, inter prediction may be applied using a reference frame that is motion compensated using the GM parameters, as described in A. K. Ramasubramonian, G. Van der Auwera, L. Pham Van, M. Karczewicz, [G-PCC]I[New proposal] Results on inter prediction for predictive geometry coding, ISO/IEC JTC1/SC29/WG7 m59650, April 2022. The GM parameters may include rotation parameters and/or translation parameters. Typically, G-PCC encoder 200 or G-PCC decoder 300 may apply global motion compensation in the Cartesian domain. In some cases, G-PCC encoder 200 or G-PCC decoder 300 may apply global motion compensation in the spherical domain.

Depending on which domain the reference frame is stored, and which domain the reference frame is compensated, one or more of Cartesian to spherical domain conversion techniques, or spherical to Cartesian domain conversion techniques may be applied, for example, by G-PCC encoder 200 or G-PCC decoder 300.

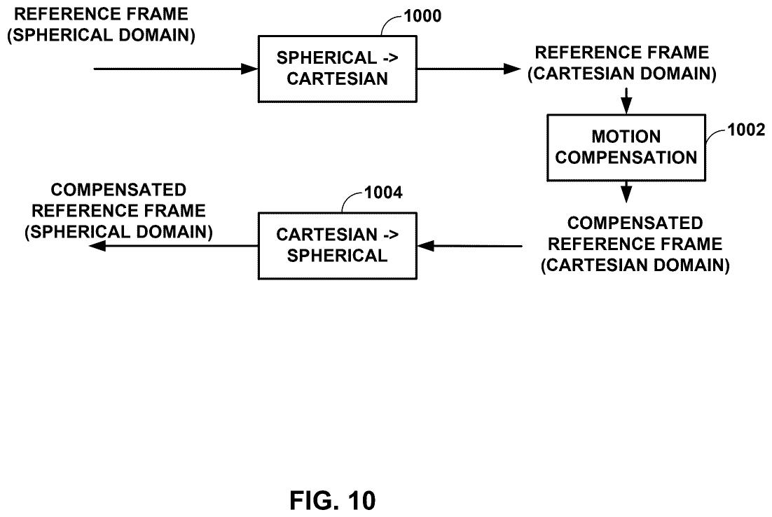

FIG. 10 is a flow diagram illustrating an example of motion compensation techniques where the reference frame is in the spherical domain and the motion compensation is applied in the Cartesian domain. For example, when the reference frame is stored in spherical domain, and the motion compensation is performed in the Cartesian domain, the motion compensation process may involve one or more of the steps shown in FIG. 10. In such cases, the compensated reference frame may be used for inter prediction.

For example, G-PCC encoder 200 or G-PCC decoder 300 may convert a reference frame from the spherical domain to the Cartesian domain (1000). G-PCC encoder 200 or G-PCC decoder 300 may apply motion compensation to the converted reference frame in the Cartesian domain (1002). G-PCC encoder 200 or G-PCC decoder 300 may convert the compensated reference frame from the Cartesian domain to the spherical domain (1004).

For example, given a position (x, y, z) in the Cartesian coordinate system, the corresponding radius and azimuthal angle may be calculated (e.g., using a floating point implementation) as follows (As a CartesianToSpherical conversion function):
int64_t r0=int64_t(std::round(hypot(xyz[0], xyz[1])));
auto phi0=std::round((atan 2(xyz[1], xyz[0])/(2.0*M_PI))*scalePhi);
   where, scalePhi is modified for different rate points in a lossy configuration; a maximum value of 24 bits is used for azimuth angle when coding the geometry losslessly. The fixed-point implementation of the azimuth is available in a convertXyZToRp1 function.

### Radius:

| | |
|---|---|
| Floating | int64_t r0 = int64_t(std::round(hypot(xyz[0], |
| implementation | xyz[1]))); |
| Fixed point | int64_t xLaser = xyz[0] << 8; |
| implementation | int64_t yLaser = xyz[1] << 8; |
| (in convertXyzToRpl) | int64_t r0 = isqrt(xLaser * xLaser + yLaser * |
| | yLaser) >> 8; |

| | |
|---|---|
| Floating | auto phi0 = std::round((atan2(xyz[1], xyz[0])/ |
| implementation | (2.0 * M_PI)) * scalePhi); |
| Fixed point | (*dst)[1] = (iatan2(yLaser, xLaser) + |
| implementation | 3294199) >> 8; |
| (in convertXyzToRpl) | |

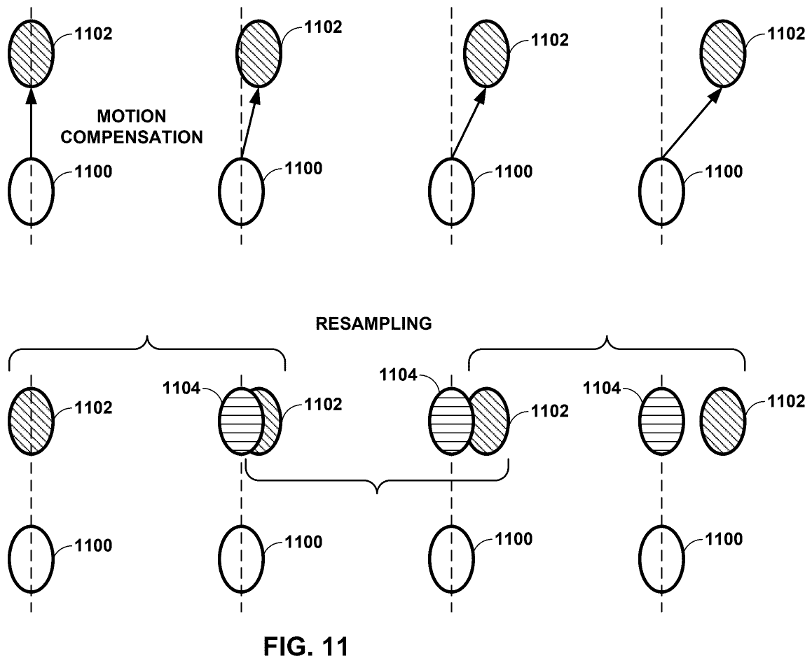

Resampling of a reference frame is now discussed. FIG. 11 is a conceptual diagram illustrating an example of azimuth resampling of motion compensated references. When global motion compensation is applied, the azimuth position of the points of the reference frame are modified depending on the motion parameters. Therefore, resampling may be needed or desired to align the azimuth points before and after compensation as illustrated in FIG. 11. The non-filled ovals represent points 1100 in an uncompensated reference frame (e.g., a reference frame without, or prior to, any global motion compensation being applied). The diagonal-line-filled ovals represent points 1102 in a global motion compensated version of the reference frame. The horizontal-line-filled ovals represent resampled points 1104 of the global motion compensated version of the reference frame. Thus, points 1100 have no global motion compensation applied, points 1102 have global motion compensation applied, and points 1104 have global motion compensation and resampling applied. As can be seen, the application of global motion compensation may cause the azimuth position of one or more of points 1102 to become misaligned with respective points of points 1100. By resampling, G-PCC encoder 200 or G-PCC decoder 300 may realign points 1102 (e.g., shown as resampled points 1104) with their respective points 1100.

G-PCC encoder 200 or G-PCC decoder 300 may apply the resampling process for each point P in the uncompensated reference frame (e.g., for each of points 1100) as follows:
A_ref is the azimuth value and L be the laser ID value associated with the point P.

If there is a point P1 (e.g., a point of points 1102) in the global-motion-compensated reference frame, which may also be referred to as a compensated reference frame, that has azimuth value equal to A_ref and laser ID equal to L, the radius of the point P is set equal to the radius of point P1, for example if G-PCC encoder 200 or G-PCC decoder 300 use a same buffer for storing the uncompensated reference frame as for storing a resampled reference frame.

Else, two points P2 and P3 are chosen in the global-motion-compensated reference frame with laser ID L such that azimuth of P2 is less than A_ref, azimuth of P3 is greater than A_ref. The radius of point P is set equal to a weighted interpolation of radii of points P2 and P3; the weights used for the interpolation is dependent on the difference between A_ref and the azimuth values of P2 and P3.

The resultant reference frame (obtained by resampling the motion compensated reference frame using azimuth values from the uncompensated reference frame), referred to as the resampled reference frame, may be used to predict the inter prediction candidates. For example, G-PCC encoder 200 or G-PCC decoder 300 may use the resampled reference frame to predict the inter prediction candidates. The two inter predictor candidates may therefore be indicated as [Res-Next, Res-NextNext], where the first part “Res” indicates that the candidates are obtained from the resampled reference frame and the second part “Next”/“NextNext” indicate the particular candidate in the reference frame (as mentioned above).

FIG. 12 is a block diagram illustrating an example of geometry encoding unit 250 of FIG. 2 in more detail. Geometry encoding unit 250 may include a coordinate transform unit 202, a voxelization unit 206, a predictive tree construction unit 207, an octree analysis unit 210, a surface approximation analysis unit 212, an arithmetic encoding unit 214, and a geometry reconstruction unit 216.

As shown in the example of FIG. 12, geometry encoding unit 250 may obtain a set of positions of points in the point cloud. In one example, geometry encoding unit 250 may obtain the set of positions of the points in the point cloud and the set of attributes from data source 104 (FIG. 1). The positions may include coordinates of points in a point cloud. Geometry encoding unit 250 may generate a geometry bitstream 203 that includes an encoded representation of the positions of the points in the point cloud.

Coordinate transform unit 202 may apply a transform to the coordinates of the points to transform the coordinates from an initial domain to a transform domain. This disclosure may refer to the transformed coordinates as transform coordinates. Voxelization unit 206 may voxelize the transform coordinates. Voxelization of the transform coordinates may include quantization and removing some points of the point cloud. In other words, multiple points of the point cloud may be subsumed within a single “voxel,” which may thereafter be treated in some respects as one point.

Prediction tree construction unit 207 may be configured to generate a prediction tree based on the voxelized transform coordinates. Prediction tree construction unit 207 may be configured to perform any of the prediction tree coding techniques described above, either in an intra-prediction mode or an inter-prediction mode. In order to perform prediction tree coding using inter-prediction, prediction tree construction unit 207 may access points from previously-encoded frames from geometry reconstruction unit 216. Dashed lines from geometry reconstruction unit 216 show data paths when inter-prediction is performed. Arithmetic encoding unit 214 may entropy encode syntax elements representing the encoded prediction tree.

Instead of performing prediction tree based coding, geometry encoding unit 250 may perform octree based coding. Octree analysis unit 210 may generate an octree based on the voxelized transform coordinates. Surface approximation analysis unit 212 may analyze the points to potentially determine a surface representation of sets of the points. Arithmetic encoding unit 214 may entropy encode syntax elements representing the information of the octree and/or surfaces determined by surface approximation analysis unit 212. Geometry encoding unit 250 may output these syntax elements in geometry bitstream 203. Geometry bitstream 203 may also include other syntax elements, including syntax elements that are not arithmetically encoded.

Octree-based coding may be performed either as intra-prediction techniques or inter-prediction techniques. In order to perform octree tree coding using inter-prediction, octree analysis unit 210 and surface approximation analysis unit 212 may access points from previously-encoded frames from geometry reconstruction unit 216. Dashed lines from geometry reconstruction unit 216 show data paths when inter-prediction is performed.

Geometry reconstruction unit 216 may reconstruct transform coordinates of points in the point cloud based on the octree, the predictive tree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points.

In some examples, spherical coordinate conversion unit 217 may perform a spherical coordinate conversion as described herein. While spherical coordinate conversion unit 217 is shown as part of geometry reconstruction unit 216 in some examples, spherical coordinate conversion unit 217 is located elsewhere in G-PCC encoder 200.

In some examples, indicator unit 215 may encode an indication of a reference status of a current data unit, such as by selecting a specific TLV type to use to encode the current data unit and/or encode a syntax element. In some examples, indicator unit 215 may select a specific TLV type to indicate other information as described herein. While indicator unit 215 is shown in arithmetic encoding unit 214, in some examples, indicator unit 215 is located elsewhere within G-PCC encoder 200.

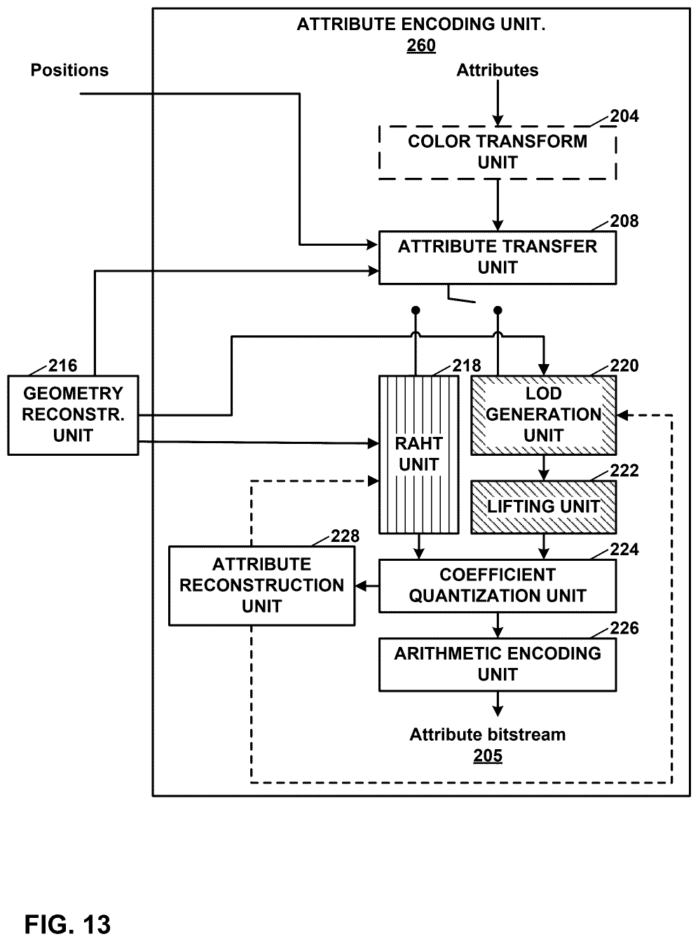

FIG. 13 is a block diagram illustrating an example of attribute encoding unit 260 of FIG. 2 in more detail. Attribute encoding unit 250 may include a color transform unit 204, an attribute transfer unit 208, an RAHT unit 218, a LoD generation unit 220, a lifting unit 222, a coefficient quantization unit 224, an arithmetic encoding unit 226, and an attribute reconstruction unit 228. Attribute encoding unit 260 may encode the attributes of the points of a point cloud to generate an attribute bitstream 205 that includes an encoded representation of the set of attributes. The attributes may include information about the points in the point cloud, such as colors associated with points in the point cloud.

Color transform unit 204 may apply a transform to transform color information of the attributes to a different domain. For example, color transform unit 204 may transform color information from an RGB color space to a YCbCr color space. Attribute transfer unit 208 may transfer attributes of the original points of the point cloud to reconstructed points of the point cloud. Attribute transfer unit 208 may use the original positions of the points as well as the positions generated from attribute encoding unit 250 (e.g., from geometry reconstruction unit 216) to make the transfer.

RAHT unit 218 may apply RAHT coding to the attributes of the reconstructed points. In some examples, under RAHT, the attributes of a block of 2×2×2 point positions are taken and transformed along one direction to obtain four low (L) and four high (H) frequency nodes. Subsequently, the four low frequency nodes (L) are transformed in a second direction to obtain two low (LL) and two high (LH) frequency nodes. The two low frequency nodes (LL) are transformed along a third direction to obtain one low (LLL) and one high (LLH) frequency node. The low frequency node LLL corresponds to DC coefficients and the high frequency nodes H, LH, and LLH correspond to AC coefficients. The transformation in each direction may be a 1-D transform with two coefficient weights. The low frequency coefficients may be taken as coefficients of the 2×2×2 block for the next higher level of RAHT transform and the AC coefficients are encoded without changes; such transformations continue until the top root node. The tree traversal for encoding is from top to bottom used to calculate the weights to be used for the coefficients; the transform order is from bottom to top. The coefficients may then be quantized and coded.

Alternatively or additionally, LoD generation unit 220 and lifting unit 222 may apply LoD processing and lifting, respectively, to the attributes of the reconstructed points. LoD generation is used to split the attributes into different refinement levels. Each refinement level provides a refinement to the attributes of the point cloud. The first refinement level provides a coarse approximation and contains few points; the subsequent refinement level typically contains more points, and so on. The refinement levels may be constructed using a distance-based metric or may also use one or more other classification criteria (e.g., subsampling from a particular order). Thus, all the reconstructed points may be included in a refinement level. Each level of detail is produced by taking a union of all points up to particular refinement level: e.g., LoD1 is obtained based on refinement level RL1, LoD2 is obtained based on RL1 and RL2, . . . LoDN is obtained by union of RL1, RL2, . . . RLN. In some cases, LoD generation may be followed by a prediction scheme (e.g., predicting transform) where attributes associated with each point in the LoD are predicted from a weighted average of preceding points, and the residual is quantized and entropy coded. The lifting scheme builds on top of the predicting transform mechanism, where an update operator is used to update the coefficients and an adaptive quantization of the coefficients is performed.

RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. G-PCC encoder 200 may output these syntax elements in attribute bitstream 205. Attribute bitstream 205 may also include other syntax elements, including non-arithmetically encoded syntax elements.

Like geometry encoding unit 250, attribute encoding unit 260 may encode the attributes using either intra-prediction or inter-prediction techniques. The above description of attribute encoding unit 260 generally describes intra-prediction techniques. In other examples, RAHT unit 218, LoD generation unit 220, and/or lifting unit 222 may also use attributes from previously-encoded frames to further encode the attributes of the current frame. In this regard, attribute reconstructions unit 228 may be configured to reconstruct the encoded attributes and store them for possible future use in inter-prediction encoding. Dashed lines from attribute reconstruction unit 228 show data paths when inter-prediction is performed.

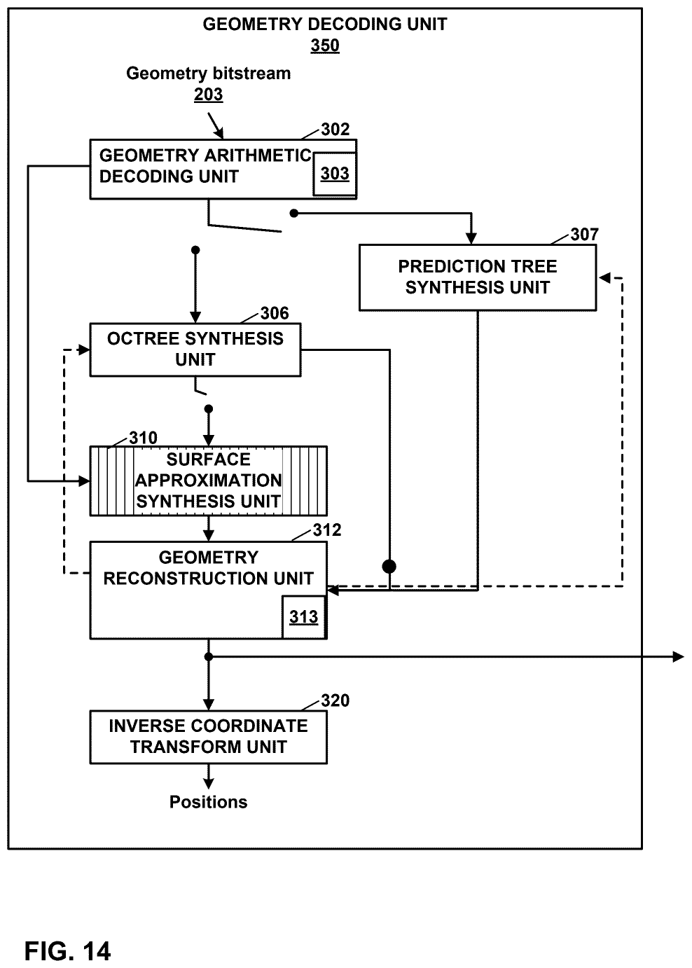

FIG. 14 is a block diagram illustrating an example geometry decoding unit 350 of FIG. 3 in more detail. Geometry decoding unit 350 may be configured to perform the reciprocal process to that performed by geometry encoding unit 250 of FIG. 2. Geometry decoding unit 350 receives geometry bitstream 203 and produces positions of the points of a point cloud frame. Geometry decoding unit 350 may include a geometry arithmetic decoding unit 302, an octree synthesis unit 306, a prediction tree synthesis unit 307, a surface approximation synthesis unit 310, a geometry reconstruction unit 312, and an inverse coordinate transform unit 320.

Geometry decoding unit 350 may receive geometry bitstream 203. Geometry arithmetic decoding unit 302 may apply arithmetic decoding (e.g., Context-Adaptive Binary Arithmetic Coding (CABAC) or other type of arithmetic decoding) to syntax elements in geometry bitstream 203.

In some examples, indicator unit 303 may decode an indication of a reference status of a current data unit, such as by selecting a specific TLV type to use to encode the current data unit and/or encode a syntax element. In some examples, indicator unit 303 may determine other information based on a specific TLV type for the current data unit as described herein. While indicator unit 303 is shown as part of geometry arithmetic decoding unit 302, in some examples, indicator unit 303 is located elsewhere in G-PCC decoder 300.

Octree synthesis unit 306 may synthesize an octree based on syntax elements parsed from geometry bitstream 203. Starting with the root node of the octree, the occupancy of each of the eight children node at each octree level is signaled in the bitstream. When the signaling indicates that a child node at a particular octree level is occupied, the occupancy of children of this child node is signaled. The signaling of nodes at each octree level is signaled before proceeding to the subsequent octree level.

At the final level of the octree, each node corresponds to a voxel position; when the leaf node is occupied, one or more points may be specified to be occupied at the voxel position. In some instances, some branches of the octree may terminate earlier than the final level due to quantization. In such cases, a leaf node is considered an occupied node that has no child nodes. In instances where surface approximation is used in geometry bitstream 203, surface approximation synthesis unit 310 may determine a surface model based on syntax elements parsed from geometry bitstream 203 and based on the octree.

Octree-based coding may be performed either as intra-prediction techniques or inter-prediction techniques. In order to perform octree tree coding using inter-prediction, octree synthesis unit 306 and surface approximation synthesis unit 310 may access points from previously-decoded frames from geometry reconstruction unit 312. Dashed lines from geometry reconstruction unit 312 show data paths when inter-prediction is performed.

Prediction tree synthesis unit may synthesize a prediction tree based on syntax elements parsed from geometry bitstream 203. Prediction tree synthesis unit 307 may be configured to synthesize the prediction tree using any of the techniques described above, including using both intra-prediction techniques or intra-prediction techniques. In order to perform prediction tree coding using inter-prediction, prediction tree synthesis unit 307 may access points from previously-decoded frames from geometry reconstruction unit 312. Dashed lines from geometry reconstruction unit 312 show data paths when inter-prediction is performed.

Geometry reconstruction unit 312 may perform a reconstruction to determine coordinates of points in a point cloud. For each position at a leaf node of the octree, geometry reconstruction unit 312 may reconstruct the node position by using a binary representation of the leaf node in the octree. At each respective leaf node, the number of points at the respective leaf node is signaled; this indicates the number of duplicate points at the same voxel position. When geometry quantization is used, the point positions are scaled for determining the reconstructed point position values.

In some examples, spherical coordinate conversion unit 313 may perform a spherical coordinate conversion as described herein. While spherical coordinate conversion unit 313 is shown as part of geometry reconstruction unit 312, in some examples, spherical coordinate conversion unit 313 is located elsewhere in G-PCC decoder 300.

Inverse transform coordinate unit 320 may apply an inverse transform to the reconstructed coordinates to convert the reconstructed coordinates (positions) of the points in the point cloud from a transform domain back into an initial domain. The positions of points in a point cloud may be in floating point domain but point positions in G-PCC codec are coded in the integer domain. The inverse transform may be used to convert the positions back to the original domain.

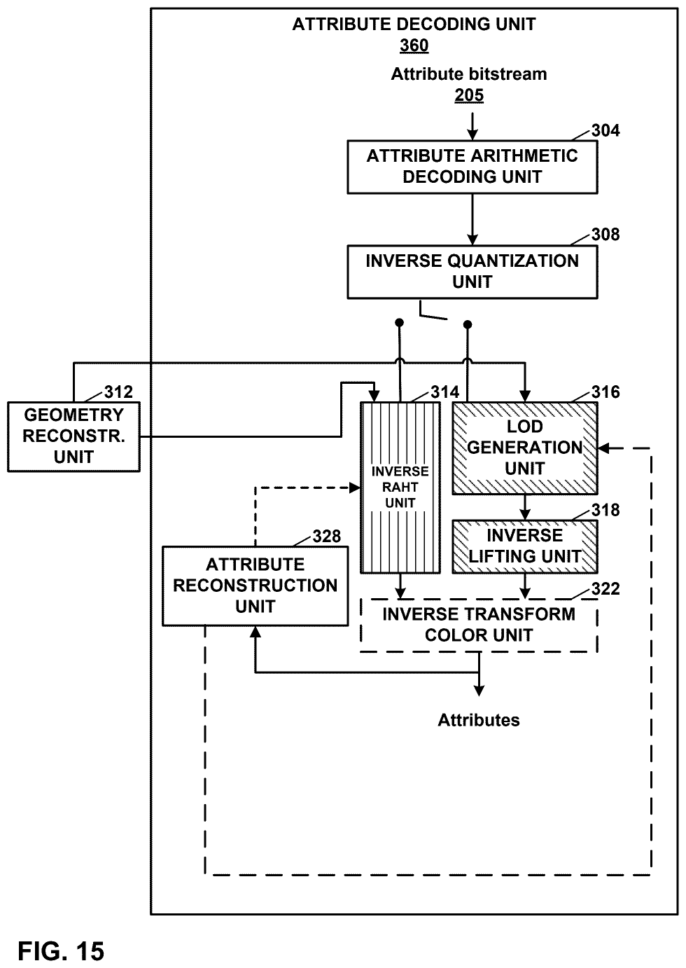

FIG. 15 is a block diagram illustrating an example attribute decoding unit 360 of FIG. 3 in more detail. Attribute decoding unit 360 may be configured to perform the reciprocal process to that performed by attribute encoding unit 260 of FIG. 2 Attribute decoding unit 360 receives attribute bitstream 205 and produces attributes of the points of a point cloud frame. Attribute decoding unit 360 may include an attribute arithmetic decoding unit 304, an inverse quantization unit 308, an inverse RAHT unit 314, an LoD generation unit 316, an inverse lifting unit 318, an inverse transform color unit 322, and an attribute reconstruction unit 328.

Attribute arithmetic decoding unit 304 may apply arithmetic decoding to syntax elements in attribute bitstream 205. Inverse quantization unit 308 may inverse quantize attribute values. The attribute values may be based on syntax elements obtained from attribute bitstream 205 (e.g., including syntax elements decoded by attribute arithmetic decoding unit 304).

Depending on how the attribute values are encoded, inverse RAHT unit 314 may perform RAHT coding to determine, based on the inverse quantized attribute values, color values for points of the point cloud. RAHT decoding is done from the top to the bottom of the tree. At each level, the low and high frequency coefficients that are derived from the inverse quantization process are used to derive the constituent values. At the leaf node, the values derived correspond to the attribute values of the coefficients. The weight derivation process for the points is similar to the process used at G-PCC encoder 200. Alternatively, LoD generation unit 316 and inverse lifting unit 318 may determine color values for points of the point cloud using a level of detail-based technique. LoD generation unit 316 decodes each LoD giving progressively finer representations of the attribute of points. With a predicting transform, LoD generation unit 316 derives the prediction of the point from a weighted sum of points that are in prior LoDs, or previously reconstructed in the same LoD. LoD generation unit 316 may add the prediction to the residual (which is obtained after inverse quantization) to obtain the reconstructed value of the attribute. When the lifting scheme is used, LoD generation unit 316 may also include an update operator to update the coefficients used to derive the attribute values. LoD generation unit 316 may also apply an inverse adaptive quantization in this case.

Furthermore, in the example of FIG. 15, inverse transform color unit 322 may apply an inverse color transform to the color values. The inverse color transform may be an inverse of a color transform applied by color transform unit 204 of G-PCC encoder 200. For example, color transform unit 204 may transform color information from an RGB color space to a YCbCr color space. Accordingly, inverse transform color unit 322 may transform color information from the YcbCr color space to the RGB color space.

Attribute reconstruction unit 328 may be configured to store attributes from previously-decoded frames. Attribute coding may be performed either as intra-prediction techniques or inter-prediction techniques. In order to perform attribute decoding using inter-prediction, inverse RAHT unit 314 and/or LoD generation unit 316 may access attributes from previously-decoded frames from attribute reconstruction unit 328. Dashed lines from attribute reconstruction unit 328 show data paths when inter-prediction is performed.

The various units of FIGS. 12-15 are illustrated to assist with understanding the operations performed by G-PCC encoder 200 and G-PCC decoder 300. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Inter prediction in octree geometry coding is now discussed. Inter prediction may also be applied when the point cloud is coded using octree coding (as opposed to predictive geometry coding). In octree geometry coding, the points in the reference frame that are near the collocated nodes of the current node (and its children) are used to select contexts which are then used in coding the occupancy of the current node (and its children). Motion compensation may be applied to derive the reference frame for the current frame.

Spherical coordinate conversion is now discussed. Spherical coordinate conversion is a technique used in G-PCC where geometry represented in the spherical coordinate system is used during attribute coding. Attribute coding typically involves the generation of levels of detail (for predicting/lifting transform), or generation RAHT tree (for RAHT transform), and both these methods make use of the geometry. When spherical coordinate conversion is not used, the geometry represented in Cartesian coordinates is used for attribute coding; a Morton scan order is chosen for parsing the points. For sparse data, such as those obtained using LIDAR sensors, using the Cartesian coordinates results in sub-optimal relationship of points in the Morton order. As the spherical coordinate system uses the sensor scan characteristics, geometry converted to the spherical coordinate system provides a much more efficient representation of the points. Morton scan order in this domain provides more meaningful relationship of points, and this improves the efficiency of coding attributes. Typically, spherical coordinate conversion is used only when the angular mode (used to code the geometry) is enabled.

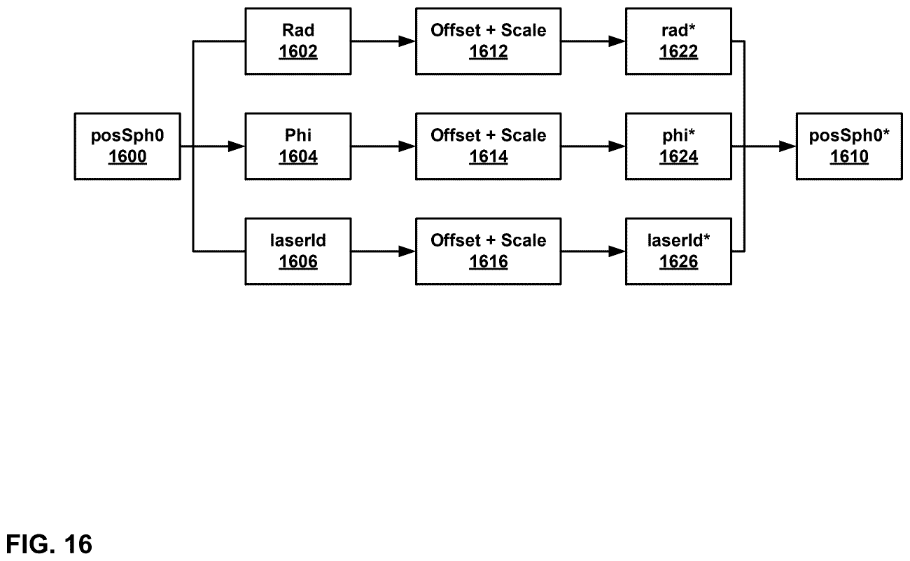

The spherical coordinate representation that is used is for attribute coding (posSph0*) is obtained by applying an offset and scale to the actual spherical coordinate representation of the geometry (posSph0). As applying offset/scale is a linear transformation. FIG. 16 is a flow diagram illustrating an example of spherical coordinate conversion according to one or more aspects of this disclosure. FIG. 16 illustrates how the radius (rad), azimuth (phi) and laser ID (laserId) that together form the spherical representation posSph0 are transformed to rad*, phi* and laserId* of the spherical representation posSph0* that is used for attribute prediction. The offset and scale values for each dimension is signaled in the attribute parameter set (APS).

For example, G-PCC encoder 200 or G-PCC decoder 300 may obtain posSph0 1600. G-PCC encoder 200 or G-PCC decoder 300 may thereby obtain the components of posSph0 1600, namely rad 1602, phi 1604, and laserId 1606. G-PCC encoder 200 or G-PCC decoder 300 may apply an offset and scale 1612 to rad 1602 to generate rad* 1622. G-PCC encoder 200 or G-PCC decoder 300 may apply an offset and scale 1614 to phi 1604 to generate phi* 1624. G-PCC encoder 200 or G-PCC decoder 300 may apply an offset and scale 1616 to laserId 1606 to generate laserId* 1626. G-PCC encoder 200 or G-PCC decoder 300 may, from components rad* 1622, phi* 1624, and laserId* 1626 generate posSph0* 1610.

The spherical coordinate conversion of a point (r, phi, 1Id) with offset (o1, o2, o3) and scale (s1, s2, s3) is performed as follows:

$$r\_scaled = ( ( r - o 1 ) * s 1 + ( 1 << 7 ) ) >> 8$$

$$phi\_scaled = ( ( phi - o 2 ) * s 2 + ( 1 << 7 ) ) >> 8$$

$$lId\_scaled = ( ( lId - o 3 ) * s 3 + ( 1 << 7 ) ) >> 8$$

The scaled coordinates (r_scaled, phi_scaled, 1Id_scaled) are then used to generate the LoDs or the RAHT layers in attribute coding.

Type-length-value encapsulated bytestream format is now discussed. The data units (DUs) of a G-PCC bitstream may be delivered as an ordered stream of bytes, and the specification supports a bytestream format for this purpose.

The bytestream format comprises a sequence of type-length-value encapsulation structures that each represent a single coded DU syntax structure. The following shows the syntax and semantics of the bytestream format, and the parsing process as defined in the G-PCC specification. In particular, the t1v_type syntax element is used to identify the payload type carried in the structure.

The following may be an example taken from a specification for G-PCC.

### B.1 General

This annex specifies the syntax and semantics of a bytestream format for use by applications that deliver DUs as an ordered stream of bytes without any requirement for further encapsulation in a file format. The bytestream format comprises a sequence of type-length-value encapsulation structures that each represent a single coded DU syntax structure.

### B.2 Syntax and Semantics

### B.2.1 Syntax

| | Descriptor |
|---|---|
| tlv_encapsulation( ) { | |
| tlv_type | u(8) |
| tlv_num_payload_bytes | u(32) |
| for(i = 0; i < tlv_num_payload_bytes; i++) | |
| tlv_payload_byte[i] | u(8) |
| } | |

### B.2.2 Semantics

The order of tlv_encapsulation structures shall follow the decoding order for the encapsulated syntax structures.

tlv_type identifies the syntax structure represented by tlv_payload_byte[ ] as specified by Table B.1.

TABLE B.1
Mapping of tlv_type and associated data unit to syntax tables

| tlv_type | Syntax table | Description |
|---|---|---|
| 0 | 7.3.2.1 | Sequence parameter set data unit |
| 1 | 7.3.2.5 | Geometry parameter set data unit |
| 2 | 7.3.3.1 | Geometry data unit |
| 3 | 7.3.2.6 | Attribute parameter set data unit |
| 4 | 7.3.4.1 | Attribute data unit |
| 5 | 7.3.2.4 | Tile inventory data unit |
| 6 | 7.3.2.8 | Frame boundary marker data unit |
| 7 | 7.3.5 | Defaulted attribute data unit |
| 8 | 7.3.2.7 | Frame-specific attribute properties data unit |
| 9 | 7.3.2.9 | User data data unit |

tlv_num_payload_bytes specifies the length in bytes of the syntax element array tlv_payload_byte[ ].

tlv_payload_byte[i] is the i-th byte of payload data.

### B.3 Parsing Process

The decoder repeatedly parses tlv_encapsulation structures until the end of the bytestream is encountered (as determined by unspecified means) and the last tlv_encapsulation structure in the bytestream has been decoded.

After parsing each tlv_encapsulation structure:
The array Data UnitBytes is set equal to tlv_payload_byte[ ].
The variable DataUnitLength is set to tlv_num_payload_bytes.

The parsing process for the syntax structure corresponding to tlv_type as specified in Table B.1 is performed.

Spherical coordinate conversion (SCC) uses a scale and offset which involves one multiplication, two additions (e.g., 1 addition and 1 subtraction), and one shift operation. A multiplication operation is typically more complex than a shift operation. Therefore, if the multiplication operation in SCC can be replaced (e.g., by a shift operation), the computational complexity for G-PCC encoder 200 and/or G-PCC decoder 300 would be reduced.

In some example implementations, there is no indication in the bitstream sent by G-PCC encoder 200 as to whether a point cloud frame may be used as a reference for prediction of another frame. As a result, G-PCC decoder 300 may store a current picture after decoding, even when no other picture may use the current picture for prediction. This results in G-PCC decoder 300 storing additional potential reference frames (e.g., pictures) that may not be needed, resulting in additional (e.g., larger) buffer requirements. Moreover, when a network element or transcoder is quickly decoding the bitstream, or a decoder (e.g., G-PCC decoder 300) is decoding the bitstream for trick play purposes, pictures that are not used for references (e.g., that are not actual reference pictures) may be discarded entirely. In the absence of an indicator, the network element/decoder/transcoder must parse the byte stream to decode syntax elements that may describe the reference picture structure. This additional parsing poses an unnecessary burden on such entities.

One or more techniques disclosed herein may be applied independently, or in any combination.

A simplified scale-offset computation for spherical coordinate conversion is now discussed. A constraint may be added to a standard to specify or require that the scale value in coordinate conversion shall (e.g., must) be a power of 2. For example, in G-PCC, the scale value is obtained with a decimal precision of 8 bits, e.g., G-PCC encoder 200 may signal a scale value of 0.375, 1, and 8, as 96, 256, and 2048, respectively. With the introduction of this constraint to G-PCC, the only signaled values that would be allowed would be 1, 2, 4, 8, 16, 32, . . . which would correspond to scale values of (1/256), (1/128), (1/64), (1/32), (1/16), . . . respectively.

For example, G-PCC encoder 200 may determine to perform spherical coordinate conversion on the current data unit. G-PCC encoder 200 may determine a spherical coordinate for geometry of the current data unit. G-PCC encoder 200 may determine a spherical coordinate for an attribute of the current data unit based on performing a scale-offset computation on the spherical coordinate for geometry. The scale-offset computation may be constrained to be a power of 2 (it should be understood that the constraint of the power of 2 may be applicable to the scale operation and may not apply to the offset operation). G-PCC encoder 200 may encode the current data unit based on the spherical coordinate for the geometry and the spherical coordinate for the attribute.

G-PCC decoder 300 may determine to perform spherical coordinate conversion on the current data unit. G-PCC decoder 300 may determine a spherical coordinate for geometry of the current data unit. G-PCC decoder 300 may determine a spherical coordinate for an attribute of the current data unit based on performing a scale-offset computation on the spherical coordinate for geometry. The scale-offset computation may be constrained to be a power of 2. G-PCC decoder 300 may decode the data unit based on the spherical coordinate for the geometry and the spherical coordinate for the attribute.

In one example, the signaling of the scale value may be converted as a log 2 value. The log 2 value may be used to derive the scale value to be used in SCC. For example, G-PCC encoder 200 may signal a syntax element indicative of a scale value of the scale-offset computation. The syntax element may indicate the scale value as a log 2 of the scale value. For example, G-PCC decoder 300 may parse a syntax element indicative of a scale value of the scale-offset computation. The syntax element may indicate the scale value as a log 2 of the scale value.

In one example, the offset operation may not be included in the SCC operation. In some cases, the offset may only be included when the resultant scale value is less than 1. For example, G-PCC encoder 200 or G-PCC decoder 300 may determine that a resultant scale value for a scale-offset computation for a second current data unit is equal to or greater than one. Based on the resultant scale value being equal to or greater than one, G-PCC encoder 200 or G-PCC decoder 300 may determine not to perform spherical coordinate conversion on the second current data unit. G-PCC encoder 200 may encode or G-PCC decoder 300 may decode the second current data unit without performing spherical coordinate conversion on the second current data unit.

Identifying reference picture status of a picture is now discussed. In one example, one or more TLV types may be specified to indicate data units that shall not be used for reference. In other words, the data units must not be used or are not used for reference. For example, one or more new TLV types may be added to existing TLV types. The new TLV types may indicate data units that shall not be used (e.g., must not be used or are not used) for reference. For example, G-PCC encoder 200 may use such a TLV type when G-PCC decoder 300 does not need to save the data units for possible reference. In the case that G-PCC decoder 300 receives in the bitstream a TLV type that indicates a current data unit shall not be used for reference, G-PCC decoder 300 may not save the current data unit as part of a future potential reference picture

In one example, one or more TLV types may be specified to indicate that data units may be used for reference. For example, one or more new TLV types may be added that indicate data units that may be used for reference. For example, G-PCC encoder 200 may use such a TLV type when G-PCC decoder 300 may need to save the data units for future possible reference as part of a future potential reference picture.

In one example, one or more TLV types may be specified explicitly to indicate: data units that are may be used for reference, and optionally, data units that shall be used for reference. For example, G-PCC encoder 200 may use such a TLV type to explicitly indicate to G-PCC decoder 300 whether G-PCC decoder 300 should save the data units for future possible reference. There may be one or more TLV types may be specified explicitly to indicate: data units that are may be used for reference, and optionally, data units that shall be used for reference. There may be one or more TLV types that may be specified explicitly to indicate data units that shall not be used for reference. For example, G-PCC encoder 200 may use such a TLV type to explicitly indicate to G-PCC decoder 300 whether G-PCC decoder 300 can discard the data units after decoding the data units rather than saving the data units for future possible reference.

For example, a data unit that may be used for reference is a data unit that G-PCC decoder 300 may or should store in memory for future reference, as that data unit is eligible to be used for reference and may potentially be used for reference. A data unit that may not be used for reference is a data unit that G-PCC decoder need not store in memory for future reference, as that data unit is not necessarily used for reference or not necessarily eligible to be used for reference, and is unlikely to be used for reference. A data unit that shall be used for reference is a data unit that will be used for reference, and thereby, G-PCC decoder 300 should store the data unit in memory for future reference. A data unit that shall not be used for reference is a data unit that will not be used for reference (e.g., for prediction) and G-PCC decoder 300 need not store the data unit in memory for future reference and may discard the data unit after decoding the data unit.

In some examples, syntax may be added in the data unit syntax structure to indicate the reference picture status as mentioned above (shall not be used for reference, may be used for reference, etc.). For example, a data unit syntax element may indicate a reference picture status of the data unit.

For example, G-PCC encoder 200 may determine a reference status of a current data unit of the point cloud data. G-PCC encoder 200 may determine, based on the reference status, a TLV type of the current data unit, the TLV type being indicative of the reference status. G-PCC encoder 200 may encode the current data unit in accordance with the TLV type.

For example, G-PCC decoder 300 may determine a TLV type of a current data unit of the point cloud data, the TLV type being indicative of a reference status of the current data unit. G-PCC decoder 300 may determine, based on the TLV type, the reference status. G-PCC decoder 300 may decode the current data unit in accordance the reference status.

Identifying prediction using TLV types is now discussed. TLV types may also be defined to indicate whether the current frame/data unit uses inter prediction or intra prediction, or alternatively, indicate the current frame/data unit is an I-, P-, or B-frame/data unit. An I-frame may be an intra-predicted frame, using only information within that frame for prediction. A P-frame may be a predicted frame, using information from one or more past frame for prediction. A B-frame may be a bi-predicted frame, using information from both past frame(s) and a future frame(s) for prediction.

In one alternative, the TLV type may be used to determine whether one or more syntax elements are included in the bitstream. For example, a particular TLV type may be indicative of one or more particular syntax elements being included (or not included) in the bitstream. For example, inter-prediction related syntax elements may not be signaled in I frames/data units, bi-prediction related syntax elements may not be signaled in I-, P-frames/data units, etc.

For example, G-PCC encoder 200 may determine at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream. G-PCC encoder 200 may determine, based on the at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream, a TLV type for the current data unit. G-PCC encoder 200 may encode the current data unit in accordance with the TLV type.

For example, G-PCC decoder 300 may determine, based on the TLV type, at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are signaled in a bitstream. G-PCC decoder 300 may decode the current data unit based on the TLV type.

In one example, the scale values used in SCC are signaled as log 2 values, which are then used to scale the coordinates as follows; the scale values for the three coordinates are s1 Log 2, s2 Log 2, s3 Log 2. G-PCC encoder 200 may signal the scale values and G-PCC decoder 300 may use the signaled scale values to scale the coordinates. In some examples, G-PCC decoder 300 may scale the coordinates as follows:

$$r\_scaled = ( ( r - o 1 ) << s 1Log2 )$$

$$phi\_scaled = ( ( phi - o 2 ) << s 2Log2 )$$

$$lId\_scaled = ( ( lId - o 3 ) << s 3Log2 )$$

In some examples, the log 2 scale value may be negative, indicating a scale value less than 1. In this case, the scaling may be performed, e.g., by G-PCC decoder 300, as follows:

$$r\_scaled = s 1 Log 2 >= 0 ? ( ( r - o 1 ) << s 1 Log 2 ) : ( ( r - o 1 ) >> - s 1 Log 2 )$$

$$phi\_scaled = s 2 Log 2 >= 0 ? ( ( phi - o 2 ) << s 2 Log 2 ) : ( ( phi - o 2 ) >> - s 2 Log 2 )$$

$$lId\_scaled = s 3 Log 2 >= 0 ? ( ( lId - o 3 ) << s 3 Log 2 ) : ( ( lId - o 3 ) >> - s 3 Log 2 )$$

In some examples, when the value to be scaled is negative, the scaling operation may be performed differently for non-negative and negative values as follows: If x is to be right shifted by value y, G-PCC decoder 300 performs the shift as follows: x>=0 ?(x>>y):−((−x)>>y)). A similar operation may be performed for left shift also. For example, G-PCC decoder 300 may perform the scaling operation differently for non-negative than for negative values.

In one example, the offset values may still be used during scaling as follows:

$$r\_scaled = ( ( r - o 1 ) << s 1Log2 + ( 1 << 7 ) ) >> 8$$

$$phi\_scaled = ( ( phi - o 2 ) << s 2Log2 + ( 1 << 7 ) ) >> 8$$

$$lId\_scaled = ( ( lId - o 3 ) << s 3Log2 + ( 1 << 7 ) ) >> 8$$

In cases that the offset is not used, the scaling may be as follows:

$$r\_scaled = ( ( r - o 1 ) << s 1 Log 2 ) >> 8$$

$$phi\_scaled = ( ( phi - o 2 ) << s 2 Log 2 ) >> 8$$

$$lId\_scaled = ( ( lId - o 3 ) << s 3 Log 2 ) >> 8$$

In this example, two additional TLV types (payload types) are defined that indicate that the data units shall not be used for prediction of other data units (e.g., they shall not be reference data units). No changes to the syntax are necessary to the corresponding data structure in this case. Additions to Table B.1, include TLVs 10 and 11 and are shown between “**/” and “/**”.

TABLE B.1
Mapping of tlv_type and associated data unit to syntax tables

| tlv_type | Syntax table | Description |
|---|---|---|
| 0 | 7.3.2.1 | Sequence parameter set data unit |
| 1 | 7.3.2.5 | Geometry parameter set data unit |
| 2 | 7.3.3.1 | Geometry data unit |
| 3 | 7.3.2.6 | Attribute parameter set data unit |
| 4 | 7.3.4.1 | Attribute data unit |
| 5 | 7.3.2.4 | Tile inventory data unit |
| 6 | 7.3.2.8 | Frame boundary marker data unit |
| 7 | 7.3.5 | Defaulted attribute data unit |
| 8 | 7.3.2.7 | Frame-specific attribute properties data unit |
| 9 | 7.3.2.9 | User data data unit |
| **/10 | 7.3.3.1 | Geometry data unit unused for reference |
| 11 | 7.3.4.1 | Attribute data unit unused for reference/** |

In one example, the decoding process may be modified such that when the TLV type indicates that the data unit is unused for reference, the data unit may be discarded after decoding the picture. For example, the data unit may be stored in any buffer only until they are needed to be output; after output, these frames may be discarded. If the reference buffer is different from the output buffer, such data units may never be included in the reference buffer. For example, G-PCC decoder 300 may store such geometry data units and/or attribute data units only until the picture is decoded and output and then the G-PCC decoder 300 may discard the picture (e.g., frame).

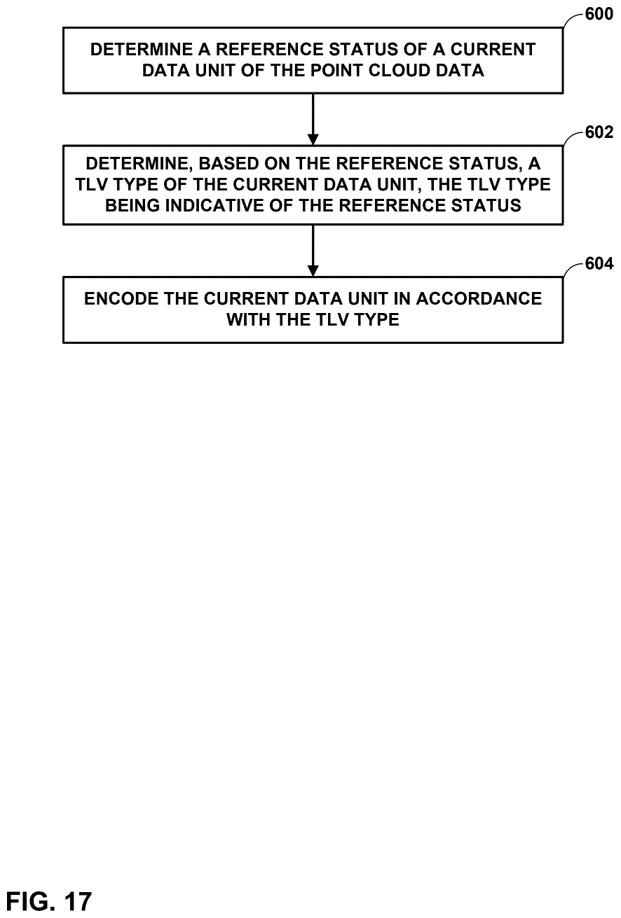

FIG. 17 is a flow diagram illustrating example point cloud encoding techniques according to one or more aspects of this disclosure. G-PCC encoder 200 may determine a reference status of a current data unit of the point cloud data (600). For example, G-PCC encoder 200 may determine that the most efficient way to encode other data units of the point cloud data is either to use or not to use the current data unit as a reference.

G-PCC encoder 200 may determine, based on the reference status, a TLV type of the current data unit, the TLV type being indicative of the reference status (602). For example, G-PCC encoder 200 may determine to use a particular TLV type which is indicative of the reference status of the current data unit.

G-PCC encoder 200 may encode the current data unit in accordance with the TLV type (604). For example, G-PCC encoder 200 may encode the current data unit as a particular TLV type that is indicative of whether the current data unit is used as a reference for another data unit.

In some examples, the reference status includes the current data unit may be used for reference or the current data unit shall not be used for reference. For example, if the reference status indicates that the current data unit may be used for reference, G-PCC encoder 200 may save the current data unit for future reference. If the reference status indicates that the current data unit shall not be used for reference, G-PCC encoder 200 may discard the current data unit after its decoding (e.g., in the decoder loop of G-PCC encoder 200) rather than save the current data unit for future reference.

In some examples, G-PCC encoder 200 may determine to perform spherical coordinate conversion on the current data unit. G-PCC encoder 200 may determine a spherical coordinate for geometry of the current data unit. G-PCC encoder 200 may determine a spherical coordinate for an attribute of the current data unit based on performing a scale-offset computation on the spherical coordinate for geometry, wherein the scale-offset computation is constrained to be a power of 2. G-PCC encoder 200 may encode the current data unit based on the spherical coordinate for the geometry and the spherical coordinate for the attribute.

In some examples, G-PCC encoder 200 may signal a syntax element indicative of a scale value of the scale-offset computation, wherein the syntax element indicates the scale value as a log 2 of the scale value. In some examples, G-PCC encoder 200 may determine at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream. G-PCC encoder 200 may determine, based on the at least one of) the prediction type used for the current data unit, b) the prediction type used for the current frame of the point cloud data, c) that the current data unit is the I-data unit, the P-data unit, or the B-data unit, d) that the current frame is the I-frame, the P-frame, or the B-frame, or e) that one or more particular syntax elements are to be signaled in the bitstream, a TLV type for the current data unit. G-PCC encoder 200 may encode the current data unit in accordance with the TLV type. In some examples, G-PCC encoder 200 may include a device to generate the point cloud data.

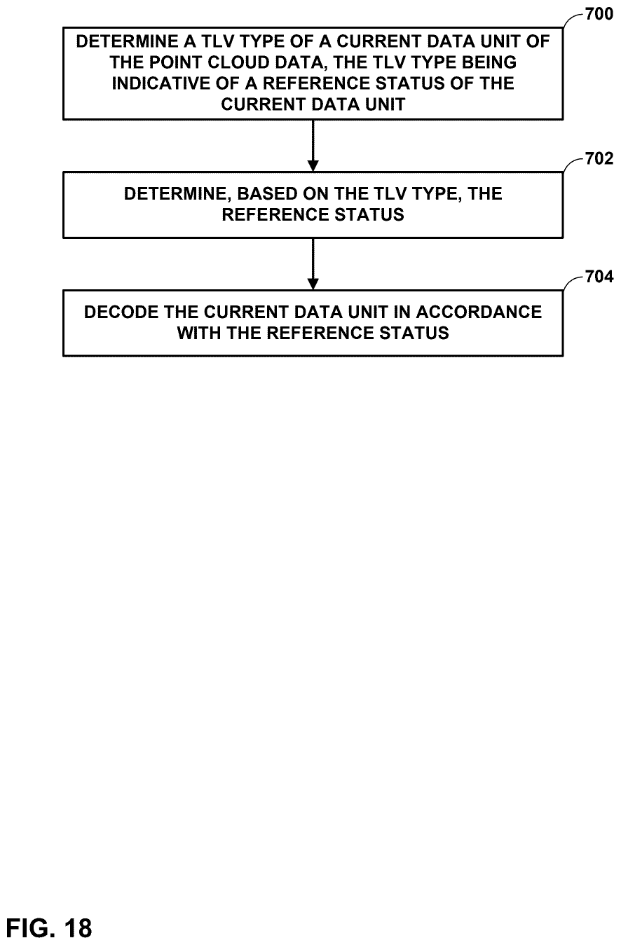

FIG. 18 is a flow diagram illustrating example point cloud decoding techniques according to one or more aspects of this disclosure. G-PCC decoder 300 may determine a TLV type of a current data unit of the point cloud data, the TLV type being indicative of a reference status of the current data unit (700). For example, G-PCC decoder 300 may determine the TLV type of the current data unit based on information contained in a bitstream.

G-PCC decoder 300 may determine, based on the TLV type, the reference status (702). For example, the TLV type may indicate whether the current data unit may be or shall not be used as a reference for other data units and G-PCC encoder 200 may encode the current data unit with a specific TLV type that indicates whether the current data unit may be or shall not be used as a reference. By determining the TLV type, G-PCC decoder 300 may thereby determine the reference status of the current data unit. In some examples, if the reference status indicates that the current data unit may be used for reference, G-PCC decoder 300 may save the current data unit for future reference. If the reference status indicates that the current data unit shall not be used for reference, G-PCC decoder 300 may discard the current data unit after its decoding rather than save the current data unit for future reference.

G-PCC decoder 300 may decode the current data unit in accordance the reference status (704). For example, G-PCC decoder 300 may or may not use the current data unit as a reference, based on the reference status of the current data unit.

In some examples, the reference status includes the current data unit may be used for reference, the current data unit may not be used for reference, the current data unit shall be used for reference, or the current data unit shall not be used for reference. In some examples, G-PCC decoder 300 may store the current data unit in the one or more memories in accordance with the reference status.

In some examples, the reference status is indicative of the current data unit being used for reference. For example, the reference status may be the current data unit shall be used for reference or the current data unit may be used for reference. In some examples, G-PCC decoder 300 may store the current data unit in the one or more memories until a point in time that occurs after a current frame of the point cloud data is output from a storage buffer.

In some examples, the reference status is indicative of the current data unit not being used for reference. For example, the reference status may be the current data unit shall not be used for reference or the current data unit may not be used for reference. In some examples, G-PCC decoder 300 may store the current data unit in the one or more memories until a current frame of the point cloud data is output from a storage buffer. G-PCC decoder 300 may delete or overwrite the current data unit in the one or more memories such that the current data unit cannot be used as a reference for a future frame of the point cloud data.

In some examples, G-PCC decoder 300 may determine to perform spherical coordinate conversion on the current data unit. G-PCC decoder 300 may determine a spherical coordinate for geometry of the current data unit. G-PCC decoder 300 may determine a spherical coordinate for an attribute of the current data unit based on performing a scale-offset computation on the spherical coordinate for geometry, wherein the scale-offset computation is constrained to be a power of 2. G-PCC decoder 300 may decode the current data unit based on the spherical coordinate for the geometry and the spherical coordinate for the attribute. In some examples, G-PCC decoder 300 may parse a syntax element indicative of a scale value of the scale-offset computation, wherein the syntax element indicates the scale value as a log 2 of the scale value.

In some examples, the current data unit is a first current data unit. In some examples, G-PCC decoder 300 may determine that a resultant scale value for a scale-offset computation for a second current data unit is equal to or greater than one. G-PCC decoder 300 may, based on the resultant scale value being equal to or greater than one, determine not to perform spherical coordinate conversion on the second current data unit. G-PCC decoder 300 may decode the second current data unit without performing spherical coordinate conversion on the second current data unit.

In some examples, G-PCC decoder 300 may G-PCC decoder 300 may determine, based on the TLV type, at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are signaled in a bitstream. G-PCC decoder 300 may decode the current data unit based on the TLV type.

In some examples, G-PCC decoder 300 may include a display to present imagery based on the point cloud data.

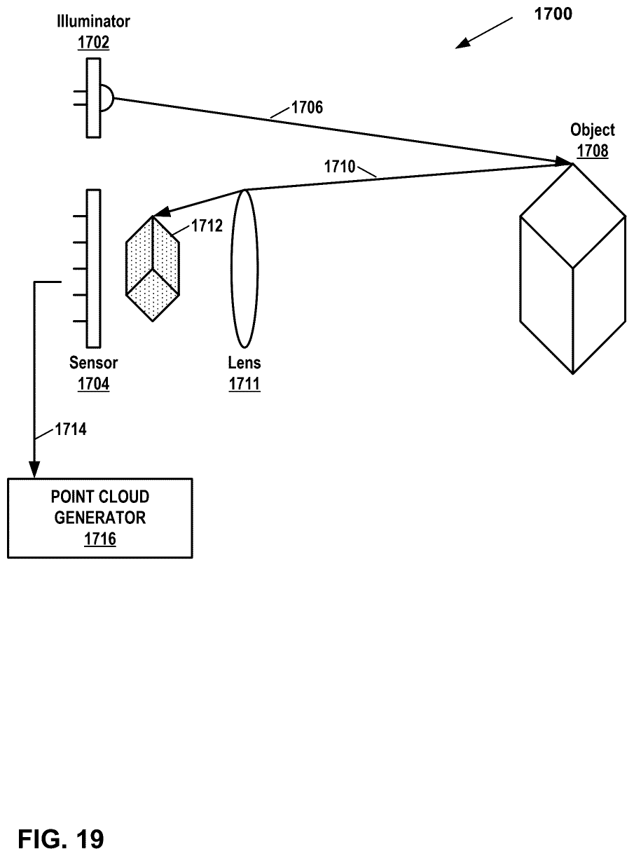

FIG. 19 is a conceptual diagram illustrating an example range-finding system 1700 that may be used with one or more techniques of this disclosure. In the example of FIG. 19, range-finding system 1700 includes an illuminator 1702 and a sensor 1704. Illuminator 1702 may emit light 1706. In some examples, illuminator 1702 may emit light 1706 as one or more laser beams. Light 1706 may be in one or more wavelengths, such as an infrared wavelength or a visible light wavelength. In other examples, light 1706 is not coherent, laser light. When light 1706 encounters an object, such as object 1708, light 1706 creates returning light 1710. Returning light 1710 may include backscattered and/or reflected light. Returning light 1710 may pass through a lens 1711 that directs returning light 1710 to create an image 1712 of object 1708 on sensor 1704. Sensor 1704 generates signals 1714 based on image 1712. Image 1712 may comprise a set of points (e.g., as represented by dots in image 1712 of FIG. 19).

In some examples, illuminator 1702 and sensor 1704 may be mounted on a spinning structure so that illuminator 1702 and sensor 1704 capture a 360-degree view of an environment (e.g., a spinning LIDAR sensor). In other examples, range-finding system 1700 may include one or more optical components (e.g., mirrors, collimators, diffraction gratings, etc.) that enable illuminator 1702 and sensor 1704 to detect ranges of objects within a specific range (e.g., up to 360-degrees). Although the example of FIG. 19 only shows a single illuminator 1702 and sensor 1704, range-finding system 1700 may include multiple sets of illuminators and sensors.

In some examples, illuminator 1702 generates a structured light pattern. In such examples, range-finding system 1700 may include multiple sensors 1704 upon which respective images of the structured light pattern are formed. Range-finding system 1700 may use disparities between the images of the structured light pattern to determine a distance to an object 1708 from which the structured light pattern backscatters. Structured light-based range-finding systems may have a high level of accuracy (e.g., accuracy in the sub-millimeter range), when object 1708 is relatively close to sensor 1704 (e.g., 0.2 meters to 2 meters). This high level of accuracy may be useful in facial recognition applications, such as unlocking mobile devices (e.g., mobile phones, tablet computers, etc.) and for security applications.

In some examples, range-finding system 1700 is a time of flight (ToF)-based system. In some examples where range-finding system 1700 is a ToF-based system, illuminator 1702 generates pulses of light. In other words, illuminator 1702 may modulate the amplitude of emitted light 1706. In such examples, sensor 1704 detects returning light 1710 from the pulses of light 1706 generated by illuminator 1702. Range-finding system 1700 may then determine a distance to object 1708 from which light 1706 backscatters based on a delay between when light 1706 was emitted and detected and the known speed of light in air). In some examples, rather than (or in addition to) modulating the amplitude of the emitted light 1706, illuminator 1702 may modulate the phase of the emitted light 1706. In such examples, sensor 1704 may detect the phase of returning light 1710 from object 1708 and determine distances to points on object 1708 using the speed of light and based on time differences between when illuminator 1702 generated light 1706 at a specific phase and when sensor 1704 detected returning light 1710 at the specific phase.

In other examples, a point cloud may be generated without using illuminator 1702. For instance, in some examples, sensors 1704 of range-finding system 1700 may include two or more optical cameras. In such examples, range-finding system 1700 may use the optical cameras to capture stereo images of the environment, including object 1708. Range-finding system 1700 may include a point cloud generator 1716 that may calculate the disparities between locations in the stereo images. Range-finding system 1700 may then use the disparities to determine distances to the locations shown in the stereo images. From these distances, point cloud generator 1716 may generate a point cloud.

Sensors 1704 may also detect other attributes of object 1708, such as color and reflectance information. In the example of FIG. 19, a point cloud generator 1716 may generate a point cloud based on signals 1714 generated by sensor 1704. Range-finding system 1700 and/or point cloud generator 1716 may form part of data source 104 (FIG. 1). Hence, a point cloud generated by range-finding system 1700 may be encoded and/or decoded according to any of the techniques of this disclosure. Inter prediction and residual prediction, as described in this disclosure may reduce the size of the encoded data.

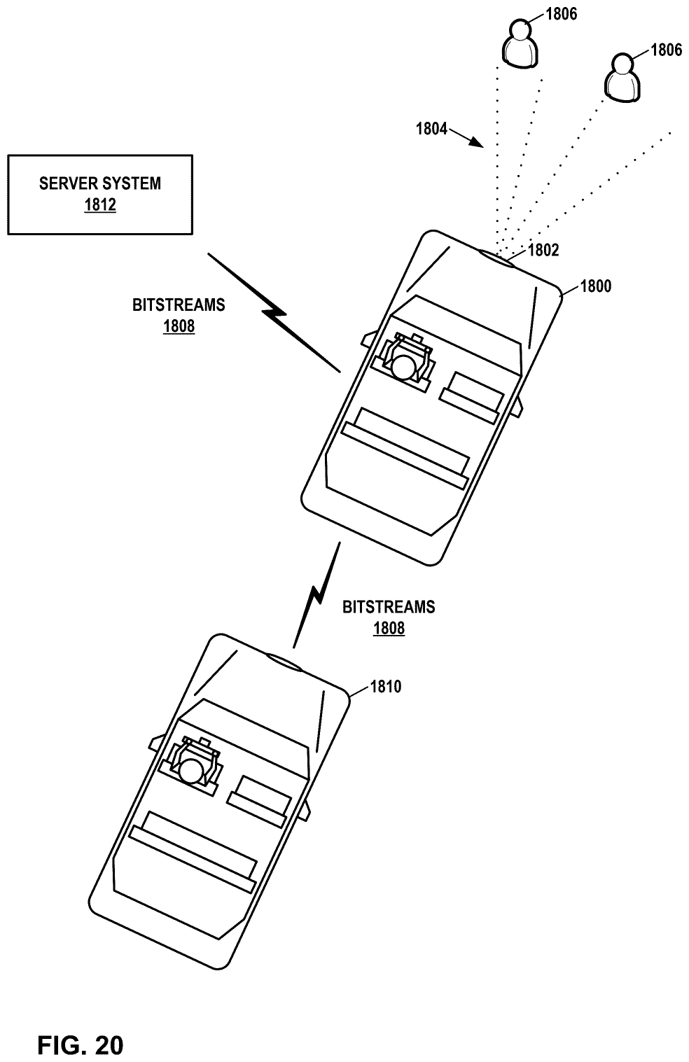

FIG. 20 is a conceptual diagram illustrating an example vehicle-based scenario in which one or more techniques of this disclosure may be used. In the example of FIG. 20, a vehicle 1800 includes a range-finding system 1802. Range-finding system 1802 may be implemented in the manner discussed with respect to FIG. 19. Although not shown in the example of FIG. 20, vehicle 1800 may also include a data source, such as data source 104 (FIG. 1), and a G-PCC encoder, such as G-PCC encoder 200 (FIG. 1). In the example of FIG. 20, range-finding system 1802 emits laser beams 1804 that reflect off pedestrians 1806 or other objects in a roadway. The data source of vehicle 1800 may generate a point cloud based on signals generated by range-finding system 1802. The G-PCC encoder of vehicle 1800 may encode the point cloud to generate bitstreams 1808, such as geometry bitstream (FIG. 2) and attribute bitstream (FIG. 2). Inter prediction and residual prediction, as described in this disclosure may reduce the size of the geometry bitstream. Bitstreams 1808 may include many fewer bits than the unencoded point cloud obtained by the G-PCC encoder.

An output interface of vehicle 1800 (e.g., output interface 108 (FIG. 1) may transmit bitstreams 1808 to one or more other devices. Bitstreams 1808 may include many fewer bits than the unencoded point cloud obtained by the G-PCC encoder. Thus, vehicle 1800 may be able to transmit bitstreams 1808 to other devices more quickly than the unencoded point cloud data. Additionally, bitstreams 1808 may require less data storage capacity on a device.

In the example of FIG. 20, vehicle 1800 may transmit bitstreams 1808 to another vehicle 1810. Vehicle 1810 may include a G-PCC decoder, such as G-PCC decoder 300 (FIG. 1). The G-PCC decoder of vehicle 1810 may decode bitstreams 1808 to reconstruct the point cloud. Vehicle 1810 may use the reconstructed point cloud for various purposes. For instance, vehicle 1810 may determine based on the reconstructed point cloud that pedestrians 1806 are in the roadway ahead of vehicle 1800 and therefore start slowing down, e.g., even before a driver of vehicle 1810 realizes that pedestrians 1806 are in the roadway. Thus, in some examples, vehicle 1810 may perform an autonomous navigation operation based on the reconstructed point cloud.

Additionally or alternatively, vehicle 1800 may transmit bitstreams 1808 to a server system 1812. Server system 1812 may use bitstreams 1808 for various purposes. For example, server system 1812 may store bitstreams 1808 for subsequent reconstruction of the point clouds. In this example, server system 1812 may use the point clouds along with other data (e.g., vehicle telemetry data generated by vehicle 1800) to train an autonomous driving system. In other example, server system 1812 may store bitstreams 1808 for subsequent reconstruction for forensic crash investigations.

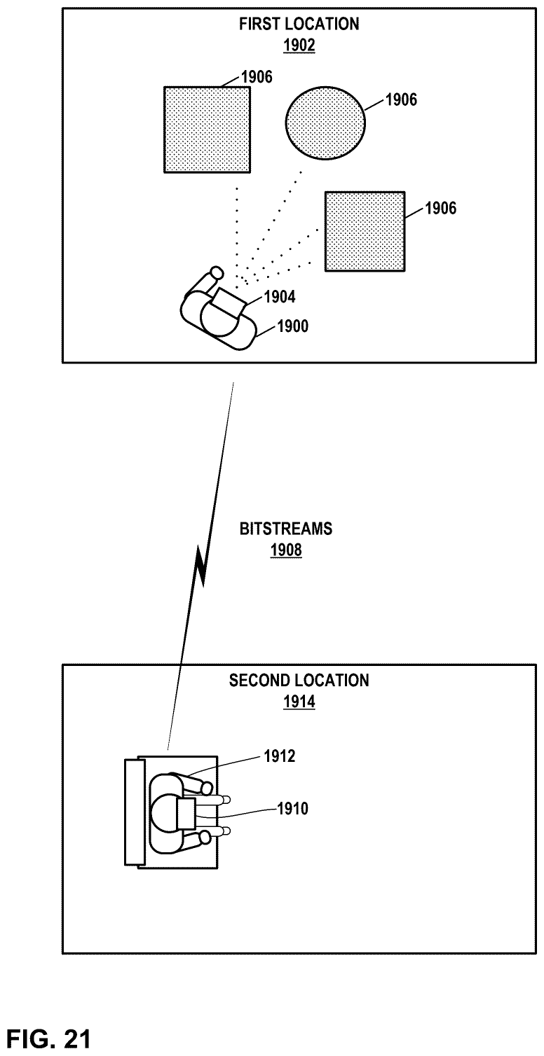

FIG. 21 is a conceptual diagram illustrating an example extended reality system in which one or more techniques of this disclosure may be used. Extended reality (XR) is a term used to cover a range of technologies that includes augmented reality (AR), mixed reality (MR), and virtual reality (VR). In the example of FIG. 21, a user 1900 is located in a first location 1902. User 1900 wears an XR headset 1904. As an alternative to XR headset 1904, user 1900 may use a mobile device (e.g., mobile phone, tablet computer, etc.). XR headset 1904 includes a depth detection sensor, such as a range-finding system, that detects positions of points on objects 1906 at location 1902. A data source of XR headset 1904 may use the signals generated by the depth detection sensor to generate a point cloud representation of objects 1906 at location 1902. XR headset 1904 may include a G-PCC encoder (e.g., G-PCC encoder 200 of FIG. 1) that is configured to encode the point cloud to generate bitstreams 1908. Inter prediction and residual prediction, as described in this disclosure may reduce the size of bitstream 1908.

XR headset 1904 may transmit bitstreams 1908 (e.g., via a network such as the Internet) to an XR headset 1910 worn by a user 1912 at a second location 1914. XR headset 1910 may decode bitstreams 1908 to reconstruct the point cloud. XR headset 1910 may use the point cloud to generate an XR visualization (e.g., an AR, MR, VR visualization) representing objects 1906 at location 1902. Thus, in some examples, such as when XR headset 1910 generates an VR visualization, user 1912 may have a 3D immersive experience of location 1902. In some examples, XR headset 1910 may determine a position of a virtual object based on the reconstructed point cloud. For instance, XR headset 1910 may determine, based on the reconstructed point cloud, that an environment (e.g., location 1902) includes a flat surface and then determine that a virtual object (e.g., a cartoon character) is to be positioned on the flat surface. XR headset 1910 may generate an XR visualization in which the virtual object is at the determined position. For instance, XR headset 1910 may show the cartoon character sitting on the flat surface.

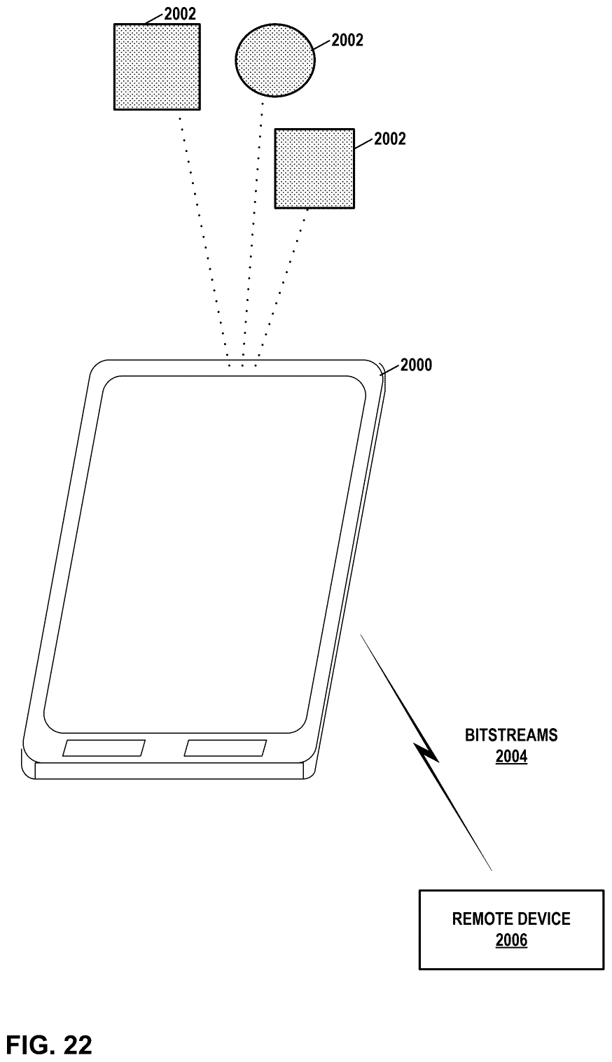

FIG. 22 is a conceptual diagram illustrating an example mobile device system in which one or more techniques of this disclosure may be used. In the example of FIG. 22, a mobile device 2000 (e.g., a wireless communication device), such as a mobile phone or tablet computer, includes a range-finding system, such as a LIDAR system, that detects positions of points on objects 2002 in an environment of mobile device 2000. A data source of mobile device 2000 may use the signals generated by the depth detection sensor to generate a point cloud representation of objects 2002. Mobile device 2000 may include a G-PCC encoder (e.g., G-PCC encoder 200 of FIG. 1) that is configured to encode the point cloud to generate bitstreams 2004. In the example of FIG. 22, mobile device 2000 may transmit bitstreams to a remote device 2006, such as a server system or other mobile device. Inter prediction and residual prediction, as described in this disclosure may reduce the size of bitstreams 2004. Remote device 2006 may decode bitstreams 2004 to reconstruct the point cloud. Remote device 2006 may use the point cloud for various purposes. For example, remote device 2006 may use the point cloud to generate a map of environment of mobile device 2000. For instance, remote device 2006 may generate a map of an interior of a building based on the reconstructed point cloud. In another example, remote device 2006 may generate imagery (e.g., computer graphics) based on the point cloud. For instance, remote device 2006 may use points of the point cloud as vertices of polygons and use color attributes of the points as the basis for shading the polygons. In some examples, remote device 2006 may use the reconstructed point cloud for facial recognition or other security applications.

Examples in the various aspects of this disclosure may be used individually or in any combination.

This disclosure includes the following non-limiting clauses.

Clause 1A. A method of processing point cloud data, the method comprising: determining to perform spherical coordinate conversion on a current data unit of the point cloud data; determining whether to perform a scale-offset computation as part of the spherical coordinate conversion; performing the spherical coordinate conversion; and coding the data unit based on the performance of the spherical coordinate conversion.

Clause 2A. The method of clause 1A, wherein a scale value of the scale-offset computation is constrained to be a power of 2.

Clause 3A. The method of clause 1A or clause 2A, further comprising signaling or parsing a syntax element indicative of a scale value of the scale-offset computation, wherein the syntax element indicates the scale value as a log 2 of the scale value.

Clause 4A. The method of clause 1A, wherein determining whether to perform a scale-offset computation as part of the spherical coordinate conversion comprises determining not to perform the scale-offset computation based on determining to perform the spherical coordinate conversion.

Clause 5A. A method of processing point cloud data, the method comprising: determining an indication of reference status of a current data unit of the point cloud data; storing the current data unit in accordance with the indication of the reference status; and coding the point cloud data in accordance with the indication of the reference status.

Clause 6A. The method of clause 5A, wherein the indication of the reference status is a TLV type.

Clause 7A. The method of clause 6A, wherein the indication of the reference status comprises a syntax element of syntax structure of the current data unit.

Clause 8A. The method of clause 6A, wherein the reference status comprises at least one of the current data unit may be used for reference, the current data unit may not be used for reference, the current data unit shall be used for reference, or the current data unit shall not be used for reference.

Clause 9A. The method of any of clauses 6A-8A, wherein the indication of the reference status comprises an indication that the current data unit is not used as a reference, and wherein the storing the current data unit in accordance with the indication of the reference status comprises: storing the current data unit until a current frame of the point cloud data is output from a storage buffer; and deleting or overwriting the current data unit such that the current data unit cannot be used as a reference for a future frame of the point cloud data.

Clause 10A. A method of processing point cloud data, the method comprising: determining a TLV type of a current data unit of the point cloud data; based on the TLV type, determine at least one of a) a prediction type used for the current data unit, b) a prediction type used for a current frame of the point cloud data including the current data unit, c) whether the current data unit I-data unit, a P-data unit, or a B-data unit, d) whether the current frame is an I-frame, a P-frame, or a B-frame, or e) whether syntax elements are signaled in a bitstream; and code the current data unit based on the TLV type.

Clause 11A. The method of any of clauses 1A-10A, further comprising generating the point cloud.

Clause 12A. A device for processing a point cloud, the device comprising one or more means for performing the method of any of clauses 1A-1A.

Clause 13A. The device of clause 12A, wherein the one or more means comprise one or more processors implemented in circuitry.

Clause 14A. The device of any of clauses 12A or 13A, further comprising a memory to store the data representing the point cloud.

Clause 15A. The device of any of clauses 12A-14A, wherein the device comprises a decoder.

Clause 16A. The device of any of clauses 12A-15A, wherein the device comprises an encoder.

Clause 17A. The device of any of clauses 12A-16A, further comprising a device to generate the point cloud.

Clause 18A. The device of any of clauses 12A-17A, further comprising a display to present imagery based on the point cloud.

Clause 19A. A computer-readable storage medium having stored thereon instructions that, when executed, cause one or more processors to perform the method of any of clauses 1A-11A.

Clause 1B. A method of decoding point cloud data, the method comprising:
determining a type-length-value (TLV) type of a current data unit of the point cloud data, the TLV type being indicative of a reference status of the current data unit; determining, based on the TLV type, the reference status; and decoding the current data unit in accordance the reference status.

Clause 2B. The method of clause 1B, wherein the reference status comprises the current data unit is eligible to be used for reference, the current data unit is not eligible to be used for reference, the current data unit shall be used for reference, or the current data unit shall not be used for reference.

Clause 3B. The method of clause 1B or clause 2B, further comprising storing the current data unit in accordance with the reference status.

Clause 4B. The method of clause 3B, wherein the reference status is indicative of the current data unit being used for reference, and wherein the method further comprises storing the current data unit until a point in time that occurs after a current frame of the point cloud data is output from a storage buffer.

Clause 5B. The method of clause 3B, wherein the reference status is indicative of the current data unit not being used for reference, and wherein the method further comprises: storing the current data unit until a current frame of the point cloud data is output from a storage buffer; and deleting or overwriting the current data unit such that the current data unit cannot be used as a reference for a future frame of the point cloud data.

Clause 6B. The method of any of clauses 1B-5B, further comprising: determining to perform spherical coordinate conversion on the current data unit; determining a spherical coordinate for geometry of the current data unit; determining a spherical coordinate for an attribute of the current data unit based on performing a scale-offset computation on the spherical coordinate for geometry, wherein the scale-offset computation is constrained to be a power of 2; and decoding the current data unit based on the spherical coordinate for the geometry and the spherical coordinate for the attribute.

Clause 7B. The method of clause 6B, further comprising parsing a syntax element indicative of a scale value of the scale-offset computation, wherein the syntax element indicates the scale value as a log 2 of the scale value.

Clause 8B. The method of clause 6B or clause 7B, wherein the current data unit is a first current data unit, the method further comprising: determining that a resultant scale value for a scale-offset computation for a second current data unit is equal to or greater than one; based on the resultant scale value being equal to or greater than one, determining not to perform spherical coordinate conversion on the second current data unit; and decoding the second current data unit without performing spherical coordinate conversion on the second current data unit.

Clause 9B. The method of any of clauses 1B-8B, further comprising: based on the TLV type, determine at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are signaled in a bitstream.

Clause 10B. A device for decoding point cloud data, the device comprising: one or more memories configured to store the point cloud data; and one or more processors operatively coupled to the one or more memories, the one or more processors configured to: determine a type-length-value (TLV) type of a current data unit of the point cloud data, the TLV type being indicative of a reference status of the current data unit; determine, based on the TLV type, the reference status; and decode the current data unit in accordance the reference status.

Clause 11B. The device of clause 10B, wherein the reference status comprises the current data unit is eligible to be used for reference, the current data unit is not eligible to be used for reference, the current data unit shall be used for reference, or the current data unit shall not be used for reference.

Clause 12B. The device of clause 10B or clause 11B, wherein the one or more processors are further configured to store the current data unit in the one or more memories in accordance with the reference status.

Clause 13B. The device of clause 12B, wherein the reference status is indicative of the current data unit being used for reference, and wherein the one or more processors are configured to store the current data unit in the one or more memories until a point in time that occurs after a current frame of the point cloud data is output from a storage buffer.

Clause 14B. The device of clause 12B, wherein the reference status is indicative of the current data unit not being used for reference, and wherein the one or more processors are configured to: store the current data unit in the one or more memories until a current frame of the point cloud data is output from a storage buffer; and delete or overwrite the current data unit in the one or more memories such that the current data unit cannot be used as a reference for a future frame of the point cloud data.

Clause 15B. The device of any of clauses 10B-14B, wherein the one or more processors are further configured to: determine to perform spherical coordinate conversion on the current data unit; determine a spherical coordinate for geometry of the current data unit; determine a spherical coordinate for an attribute of the current data unit based on performing a scale-offset computation on the spherical coordinate for geometry, wherein the scale-offset computation is constrained to be a power of 2; and decode the current data unit based on the spherical coordinate for the geometry and the spherical coordinate for the attribute.

Clause 16B. The device of clause 15B, wherein the one or more processors are further configured to parse a syntax element indicative of a scale value of the scale-offset computation, wherein the syntax element indicates the scale value as a log 2 of the scale value.

Clause 17B. The device of clause 15B or 16B, wherein the current data unit is a first current data unit, and wherein the one or more processors are further configured to: determine that a resultant scale value for a scale-offset computation for a second current data unit is equal to or greater than one; based on the resultant scale value being equal to or greater than one, determine not to perform spherical coordinate conversion on the second current data unit; and decode the second current data unit without performing spherical coordinate conversion on the second current data unit.

Clause 18B. The device of any of clauses 10B-17B, wherein the one or more processors are further configured to: determine, based on the TLV type, at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are signaled in a bitstream.

Clause 19B. The device of any of clauses 10B-18B, further comprising a display to present imagery based on the point cloud data.

Clause 20B. A method of encoding point cloud data, the method comprising: determining a reference status of a current data unit of the point cloud data; determining, based on the reference status, a type-length-value (TLV) type of the current data unit, the TLV type being indicative of the reference status; and encoding the current data unit in accordance with the TLV type.

Clause 21B. The method of clause 20B, wherein the reference status comprises the current data unit is eligible to be used for reference, the current data unit is not eligible to be used for reference, the current data unit shall be used for reference, or the current data unit shall not be used for reference.

Clause 22B. The method of clause 20B or clause 21B, further comprising: determining to perform spherical coordinate conversion on the current data unit; determining a spherical coordinate for geometry of the current data unit; determining a spherical coordinate for an attribute of the current data unit based on performing a scale-offset computation on the spherical coordinate for geometry, wherein the scale-offset computation is constrained to be a power of 2; and encoding the current data unit based on the spherical coordinate for the geometry and the spherical coordinate for the attribute.

Clause 23B. The method of clause 22B, further comprising signaling a syntax element indicative of a scale value of the scale-offset computation, wherein the syntax element indicates the scale value as a log 2 of the scale value.

Clause 24B. The method of any of clauses 20B-23B, further comprising: determining at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream; and determining, based on the at least one of a) the prediction type used for the current data unit, b) the prediction type used for the current frame of the point cloud data, c) that the current data unit is the I-data unit, the P-data unit, or the B-data unit, d) that the current frame is the I-frame, the P-frame, or the B-frame, or e) that one or more particular syntax elements are to be signaled in the bitstream, a TLV type for the current data unit.

Clause 25B. A device for encoding point cloud data, the device comprising: one or more memories configured to store the point cloud data; and one or more processors operatively coupled to the one or more memories, the one or more processors configured to: determine a reference status of a current data unit of the point cloud data; determine, based on the reference status, a type-length-value (TLV) type of the current data unit, the TLV type being indicative of the reference status; and encode the current data unit in accordance with the TLV type.

Clause 26B. The device of clause 25B, wherein the reference status comprises the current data unit is eligible to be used for reference, the current data unit is not eligible to be used for reference, the current data unit shall be used for reference, or the current data unit shall not be used for reference.

Clause 27B. The device of clause 25B or clause 26B, wherein the one or more processors are further configured to: determine to perform spherical coordinate conversion on the current data unit; determine a spherical coordinate for geometry of the current data unit; determine a spherical coordinate for an attribute of the current data unit based on performing a scale-offset computation on the spherical coordinate for geometry, wherein the scale-offset computation is constrained to be a power of 2; and encode the current data unit based on the spherical coordinate for the geometry and the spherical coordinate for the attribute.

Clause 28B. The device of clause 27B, wherein the one or more processors are further configured to signal a syntax element indicative of a scale value of the scale-offset computation, wherein the syntax element indicates the scale value as a log 2 of the scale value.

Clause 29B. The device of any of clauses 25B-28B, wherein the one or more processors are further configured to: determine at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream; and determine, based on the at least one of a) the prediction type used for the current data unit, b) the prediction type used for the current frame of the point cloud data, c) that the current data unit is the I-data unit, the P-data unit, or the B-data unit, d) that the current frame is the I-frame, the P-frame, or the B-frame, or e) that one or more particular syntax elements are to be signaled in the bitstream, a TLV type for the current data unit.

Clause 30B. The device of any of clauses 25B-29B, further comprising a device to generate the point cloud data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding point cloud data, the method comprising:
determining a type-length-value (TLV) type of a current data unit of the point cloud data, the TLV type being indicative of a reference status of the current data unit;
determining, based on the TLV type, the reference status; and
decoding the current data unit in accordance the reference status.

2. The method of claim 1, wherein the reference status comprises the current data unit is eligible to be used for reference, the current data unit is not eligible to be used for reference, the current data unit shall be used for reference, or the current data unit shall not be used for reference.

3. The method of claim 1, further comprising storing the current data unit in accordance with the reference status.

4. The method of claim 3, wherein the reference status is indicative of the current data unit being used for reference, and wherein the method further comprises:
storing the current data unit until a point in time that occurs after a current frame of the point cloud data is output from a storage buffer.

5. The method of claim 3, wherein the reference status is indicative of the current data unit not being used for reference, and wherein the method further comprises:
storing the current data unit until a current frame of the point cloud data is output from a storage buffer; and
deleting or overwriting the current data unit such that the current data unit cannot be used as a reference for a future frame of the point cloud data.

6. The method of claim 1, further comprising:
determining to perform spherical coordinate conversion on the current data unit;
determining a spherical coordinate for geometry of the current data unit;
determining a spherical coordinate for an attribute of the current data unit based on performing a scale-offset computation on the spherical coordinate for geometry, wherein the scale-offset computation is constrained to be a power of 2; and
decoding the current data unit based on the spherical coordinate for the geometry and the spherical coordinate for the attribute.

7. The method of claim 6, further comprising parsing a syntax element indicative of a scale value of the scale-offset computation, wherein the syntax element indicates the scale value as a log 2 of the scale value.

8. The method of claim 6, wherein the current data unit is a first current data unit, the method further comprising:
determining that a resultant scale value for a scale-offset computation for a second current data unit is equal to or greater than one;
based on the resultant scale value being equal to or greater than one, determining not to perform spherical coordinate conversion on the second current data unit; and
decoding the second current data unit without performing spherical coordinate conversion on the second current data unit.

9. The method of claim 1, further comprising:
based on the TLV type, determine at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are signaled in a bitstream.

10. A device for decoding point cloud data, the device comprising:
one or more memories configured to store the point cloud data: and
one or more processors operatively coupled to the one or more memories, the one or more processors configured to:
determine a type-length-value (TLV) type of a current data unit of the point cloud data, the TLV type being indicative of a reference status of the current data unit;
determine, based on the TLV type, the reference status; and
decode the current data unit in accordance the reference status.

11. The device of claim 10, wherein the reference status comprises the current data unit is eligible to be used for reference, the current data unit is not eligible to be used for reference, the current data unit shall be used for reference, or the current data unit shall not be used for reference.

12. The device of claim 10, wherein the one or more processors are further configured to store the current data unit in the one or more memories in accordance with the reference status.

13. The device of claim 12, wherein the reference status is indicative of the current data unit being used for reference, and wherein the one or more processors are configured to:
store the current data unit in the one or more memories until a point in time that occurs after a current frame of the point cloud data is output from a storage buffer.

14. The device of claim 12, wherein the reference status is indicative of the current data unit not being used for reference, and wherein the one or more processors are configured to:
store the current data unit in the one or more memories until a current frame of the point cloud data is output from a storage buffer; and
delete or overwrite the current data unit in the one or more memories such that the current data unit cannot be used as a reference for a future frame of the point cloud data.

15. The device of claim 10, wherein the one or more processors are further configured to:
determine to perform spherical coordinate conversion on the current data unit;
determine a spherical coordinate for geometry of the current data unit;
determine a spherical coordinate for an attribute of the current data unit based on performing a scale-offset computation on the spherical coordinate for geometry, wherein the scale-offset computation is constrained to be a power of 2; and
decode the current data unit based on the spherical coordinate for the geometry and the spherical coordinate for the attribute.

16. The device of claim 15, wherein the one or more processors are further configured to parse a syntax element indicative of a scale value of the scale-offset computation, wherein the syntax element indicates the scale value as a log 2 of the scale value.

17. The device of claim 10, wherein the current data unit is a first current data unit, and wherein the one or more processors are further configured to:
determine that a resultant scale value for a scale-offset computation for a second current data unit is equal to or greater than one;
based on the resultant scale value being equal to or greater than one, determine not to perform spherical coordinate conversion on the second current data unit; and
decode the second current data unit without performing spherical coordinate conversion on the second current data unit.

18. The device of claim 10, wherein the one or more processors are further configured to:
determine, based on the TLV type, at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are signaled in a bitstream.

19. The device of claim 10, further comprising a display to present imagery based on the point cloud data.

20. A method of encoding point cloud data, the method comprising:
determining a reference status of a current data unit of the point cloud data;
determining, based on the reference status, a type-length-value (TLV) type of the current data unit, the TLV type being indicative of the reference status; and
encoding the current data unit in accordance with the TLV type.

21. The method of claim 20, wherein the reference status comprises the current data unit is eligible to be used for reference, the current data unit is not eligible to be used for reference, the current data unit shall be used for reference, or the current data unit shall not be used for reference.

22. The method of claim 20, further comprising:
determining to perform spherical coordinate conversion on the current data unit;
determining a spherical coordinate for geometry of the current data unit;
determining a spherical coordinate for an attribute of the current data unit based on performing a scale-offset computation on the spherical coordinate for geometry, wherein the scale-offset computation is constrained to be a power of 2; and
encoding the current data unit based on the spherical coordinate for the geometry and the spherical coordinate for the attribute.

23. The method of claim 22, further comprising signaling a syntax element indicative of a scale value of the scale-offset computation, wherein the syntax element indicates the scale value as a log 2 of the scale value.

24. The method of claim 20, further comprising:
determining at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream; and
determining, based on the at least one of a) the prediction type used for the current data unit, b) the prediction type used for the current frame of the point cloud data, c) that the current data unit is the I-data unit, the P-data unit, or the B-data unit, d) that the current frame is the I-frame, the P-frame, or the B-frame, or e) that one or more particular syntax elements are to be signaled in the bitstream, a TLV type for the current data unit.

25. A device for encoding point cloud data, the device comprising:
one or more memories configured to store the point cloud data: and
one or more processors operatively coupled to the one or more memories, the one or more processors configured to:
determine a reference status of a current data unit of the point cloud data;
determine, based on the reference status, a type-length-value (TLV) type of the current data unit, the TLV type being indicative of the reference status; and
encode the current data unit in accordance with the TLV type.

26. The device of claim 25, wherein the reference status comprises the current data unit is eligible to be used for reference, the current data unit is not eligible to be used for reference, the current data unit shall be used for reference, or the current data unit shall not be used for reference.

27. The device of claim 25, wherein the one or more processors are further configured to:
determine to perform spherical coordinate conversion on the current data unit;
determine a spherical coordinate for geometry of the current data unit;
determine a spherical coordinate for an attribute of the current data unit based on performing a scale-offset computation on the spherical coordinate for geometry, wherein the scale-offset computation is constrained to be a power of 2; and
encode the current data unit based on the spherical coordinate for the geometry and the spherical coordinate for the attribute.

28. The device of claim 27, wherein the one or more processors are further configured to signal a syntax element indicative of a scale value of the scale-offset computation, wherein the syntax element indicates the scale value as a log 2 of the scale value.

29. The device of claim 25, wherein the one or more processors are further configured to:
determine at least one of a) a prediction type used for the current data unit, b) a prediction type used for a current frame of the point cloud data, the current frame including the current data unit, c) that the current data unit is an I-data unit, a P-data unit, or a B-data unit, d) that the current frame is an I-frame, a P-frame, or a B-frame, or e) that one or more particular syntax elements are to be signaled in a bitstream; and
determine, based on the at least one of a) the prediction type used for the current data unit, b) the prediction type used for the current frame of the point cloud data, c) that the current data unit is the I-data unit, the P-data unit, or the B-data unit, d) that the current frame is the I-frame, the P-frame, or the B-frame, or e) that one or more particular syntax elements are to be signaled in the bitstream, a TLV type for the current data unit.

30. The device of claim 25, further comprising a device to generate the point cloud data.
